(19) United States
(12) Patent Application Publication
(10) Pub. No.: US 2025/0095384 A1
(43) Pub. Date: Mar. 20, 2025

(54) ASSOCIATING DETECTED OBJECTS AND TRAFFIC LANES USING COMPUTER VISION

(71) Applicant: TORC Robotics, Inc., Blacksburg, VA (US)

(72) Inventors: Daniel MOODIE, Blacksburg, VA (US); Siddartha Yeliyur Shivakumara SWAMY, Blacksburg, VA (US); Indrajeet Kumar MISHRA, Blacksburg, VA (US); Christopher DUSOLD, Blacksburg, VA (US); Cody MCCLINTOCK, Blacksburg, VA (US); Ruifang WANG, Blacksburg, VA (US)

(73) Assignee: TORC Robotics, Inc., Blacksburg, VA (US)

(21) Appl. No.: 18/370,830

(22) Filed: Sep. 20, 2023

(51) Int. Cl. G06V 20/56; G06V 20/58; G06V 20/70

(52) U.S. Cl. CPC G06V 20/588; G06V 20/58; G06V 20/70

(57) ABSTRACT

Embodiments herein include an automated vehicle performing for identifying vehicles and lanes in roadway by an autonomy system of an automated vehicle. The autonomy system gathers image inputs from cameras or other sensors. The autonomy system assigns index values to the driving lanes and shoulder lanes, and then assigns the index values to the vehicles. The autonomy system generates data segments from the image data, corresponding to creating segments of an image, such that a single image is segmented for portions of the image, such as segmented outputs of each lane line or segmented outputs of portions of the vehicle. The autonomy system compares the segmented portions of the image to detect that a lane contains a vehicle.

### FIELD

The present disclosure relates generally to automated vehicles, including systems and methods for recognizing traffic lanes and objects relative to an automated vehicle.

### BACKGROUND

The use of automated vehicles has become increasingly prevalent in recent years, with the potential for numerous benefits, such as improved safety, reduced traffic congestion, and increased mobility for people with disabilities. However, with the deployment of automated vehicles on public roads, there is a growing concern about interactions between automated vehicles and negligent actors (whether human drivers or other autonomous systems) operating other vehicles on the road.

For proper operation, automated vehicles can collect large amounts of data regarding the surrounding environment. Such data may include data regarding other vehicles driving on the road, identifications of traffic regulations that apply (e.g., speed limits from speed limit signs or traffic lights), or other objects that impact how automated vehicles may drive safely.

Automated vehicles may collect data regarding an operating environment of an automated vehicle, including traffic vehicles and other objects within the operating environment, as well as identifying and navigating traffic lanes. This information allows the automated vehicle to navigate the environment by observing, predicting, and reacting to actions or trajectories of the objects or other vehicles on the road or within the broader operating environment. For instance, the automated vehicles should identify other traffic vehicles situated on the roadway or on the shoulder of the road to avoid unexpected actions.

### SUMMARY

The systems and methods of the present disclosure may solve the problems set forth above and/or other problems in the art. Described herein are systems and methods for improved detection of vehicles on a roadway and lanes on the roadway. Embodiments herein include an automated vehicle performing for identifying vehicles and lanes in roadway by an autonomy system of an automated vehicle. The autonomy system gathers image inputs from cameras or other sensors. The autonomy system assigns index values to the driving lanes and shoulder lanes, and then assigns the index values to the vehicles. The autonomy system generates data segments from the image data, corresponding to creating segments of an image, such that a single image is segmented for portions of the image, such as segmented outputs of each lane line or segmented outputs of portions of the vehicle. The autonomy system compares the segmented portions of the image to detect that a lane contains a vehicle.

In an embodiment, a method for managing location information in automated vehicles, the method comprising: obtaining, by a processor of the automated vehicle, image data from a camera on the automated vehicle, the image data includes a digital representation of imagery in a field-of-view of the camera including an operational environment with one or more objects and a roadway having one or more driving lanes; for each driving lane of the one or more lanes, applying, by the processor, to the image data a lane label associated with the particular lane and indicating a lane index value; determining, by the processor, the driving lane of the one or more driving lanes containing the object; and updating, by the processor, the image data by applying an object label indicating the lane index value for the driving lane having the object.

In another embodiment, a system for managing location information in automated vehicles, the system comprising: a datastore of an automated vehicle comprising non-transitory machine-readable storage configured to store image data from a camera of the automated vehicle, the image data includes a digital representation of imagery in a field-of-view of the camera including an operational environment with one or more objects and a roadway having one or more driving lanes; and a processor configured to execute the executable instructions, configured to: obtain a single snapshot of the image data of the camera from the datastore; for each driving lane of the one or more lanes, applying to the image data a lane label associated with the particular lane and indicating a lane index value; determine the driving lane of the one or more driving lanes containing the object; and update the image data by applying an object label indicating the lane index value for the driving lane having the object.

In another embodiment, a method for managing location information in automated vehicles, the method comprising: obtaining, by a processor of an automated vehicle, image data from a camera on the automated vehicle, the image data includes a digital representation of imagery in a field-of-view of the camera including an operational environment with one or more objects including a vehicle and a roadway having a plurality of lanes; identifying, by the processor, in the image data the vehicle and the one or more lanes; determining, by the processor, that the vehicle is situated in a shoulder lane of the plurality of lanes of the roadway; for each lane, applying, by the processor, to the image data a lane label associated with the particular lane; and updating, by the processor, the image data by applying a vehicle label indicating the shoulder lane for the vehicle.

In another embodiment, a system for managing location information in automated vehicles, the system comprising: a datastore of an automated vehicle comprising non-transitory machine-readable storage configured to store image data from a camera of the automated vehicle, the image data includes a digital representation of imagery in a field-of-view of the camera including an operational environment with one or more objects and a roadway having one or more driving lanes; and a processor configured to execute the executable instructions, configured to: obtain a single snapshot of the image data of the camera from the datastore; identify in the image data the vehicle and the one or more lanes; determine that the vehicle is situated in a shoulder lane of the plurality of lanes of the roadway; for each lane, apply to the image data a lane label associated with the particular lane; and update the image data by applying a vehicle label indicating the shoulder lane for the vehicle.

In another embodiment, a method for managing location information in automated vehicles, the method comprising: obtaining, by a processor of an automated vehicle, image data from a camera on the automated vehicle, the image data includes a digital representation of imagery in a field-of-view of the camera including an operational environment with one or more objects and a roadway having a plurality of lanes; identifying, by the processor, the plurality of lanes in digital image of the roadway; identifying, by the processor, in the image data a vehicle as an object situated in the roadway; generating, by the processor, a plurality of image segments of the image data, each image segment containing a portion of the vehicle in the image data; and detecting, by the processor, the lane containing at least a portion of the vehicle in response to determining that at least one image segment intersects the lane in the image data of the roadway.

In another embodiment, a system for managing location information in automated vehicles, the system comprising: a datastore of an automated vehicle comprising non-transitory machine-readable storage configured to store image data from a camera of the automated vehicle, the image data includes a digital representation of imagery in a field-of-view of the camera including an operational environment with one or more objects and a roadway having one or more driving lanes; and a processor configured to execute the executable instructions, configured to: obtain a single snapshot of the image data of the camera from the datastore; identify the plurality of lanes in digital image of the roadway; identify in the image data a vehicle as an object situated in the roadway; generate a plurality of image segments of the image data, each image segment containing a portion of the vehicle in the image data; and detect the lane containing at least a portion of the vehicle in response to determining that at least one image segment intersects the lane in the image data of the roadway.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views. The accompanying drawings, which are incorporated in and constitute a part of this specification, illustrate various exemplary embodiments and together with the description, serve to explain the principles of the disclosed embodiments.

FIG. 1 is a bird's-eye view of a roadway including a schematic representation of a vehicle and aspects of an autonomy system of the vehicle, according to an embodiment.

FIG. 2 is a schematic of the autonomy system of an automated vehicle, according to an embodiment.

FIG. 3 is a controller for localizing a vehicle using real time data, such as in the scenario depicted in FIG. 1, according to an embodiment.

FIG. 4 depicts operations of a process for handling image data gathered by an automated vehicle, according to an embodiment.

FIG. 5 shows operations of a process for localizing an ego vehicle, according to an embodiment.

FIG. 6 is a block diagram of showing data flow amongst components of an autonomy system, including executable programming of one or more machine-learning models for a lane analysis module, according to an embodiment.

FIG. 7 is flowchart diagram showing operations of a method for training machine learning models of an autonomy system of an automated vehicle for generating lane indices based on image data, according to an embodiment.

FIG. 8 shows operations of a method for using machine learning models of an autonomy system of an automated vehicle to predict a lane index using real time image data, according to an embodiment.

FIG. 9A depicts image data of an example of bird's eye view image of a roadway generated by an autonomy system of an automated vehicle, according to an embodiment.

FIG. 9B depicts another example of image data of an example image of a roadway generated by the autonomy system of the automated vehicle, according to the embodiment.

FIG. 10 shows operations of a method for recognizing lanes and objects by an autonomy system that manages operations of an automated vehicle, according to an embodiment.

FIG. 11 shows operations of a method for recognizing lanes and objects by an autonomy system that manages operations of an automated vehicle, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Embodiments described herein relate to automated vehicles having computer-driven automated driver systems (sometimes referred to as “autonomy systems”). The automated vehicle may be completely autonomous (fully-autonomous), such as self-driving, driverless, or SAE Level 4 autonomy, or semi-autonomous, such as SAE Level 3 autonomy. As used herein the terms “automated vehicle” and “automated vehicle” includes both fully-autonomous and semi-automated vehicles. The present disclosure sometimes refers to automated vehicles as “ego vehicles.”

Automated vehicle virtual driver systems are structured on three pillars of technology: 1) perception, 2) maps/localization, and 3) behaviors planning and control. The mission of perception is to sense an environment surrounding an ego vehicle and interpret it. To interpret the surrounding environment, a perception engine may identify and classify objects or groups of objects in the environment. For example, an autonomous system may use a perception engine to identify one or more objects (e.g., pedestrians, vehicles, debris, etc.) in the road before a vehicle and classify the objects in the road as distinct from the road. The mission of maps/localization is to figure out where in the world, or where on a pre-built map, is the ego vehicle. One way to do this is to sense the environment surrounding the ego vehicle (e.g., perception systems) and to correlate features of the sensed environment with details (e.g., digital representations of the features of the sensed environment) on a digital map. Once the systems on the ego vehicle have determined its location with respect to the map features (e.g., intersections, road signs) the ego vehicle (or “ego”) can plan maneuvers and/or routes with respect to the features of the environment. The mission of behaviors, planning, and control is to make decisions about how the ego should move through the environment to get to its goal or destination. The autonomy system consumes information from the perception engine and the maps/localization modules to know where it is relative to the surrounding environment and what other traffic actors are doing.

Localization, or the estimate of ego vehicle's position to varying degrees of accuracy, often with respect to one or more landmarks on a map, is critical information that may enable advanced driver-assistance systems or self-driving cars to execute autonomous driving maneuvers. Such maneuvers can often be mission or safety related. For example, localization may be a prerequisite for an ADAS or a self-driving car to provide intelligent and autonomous driving maneuvers to arrive at point C from points B and A. Currently existing solutions for localization may rely on a combination of Global Navigation Satellite System (GNSS), an inertial measurement unit (IMU), and a digital map (e.g., an HD map or other map file including one or more semantic layers).

Localizations can be expressed in various forms based on the medium in which they may be expressed. For example, a vehicle could be globally localized using a global positioning reference frame, such as latitude and longitude. The relative location of the ego vehicle with respect to one or more objects or features in the surrounding environment could then be determined with knowledge of ego vehicle's global location and the knowledge of the one or more objects' or feature's global location(s). Alternatively, an ego vehicle could be localized with respect to one or more features directly. To do so, the ego vehicle may identify and classify one or more objects or features in the environment and may do this using, for example, its own on board sensing systems (e.g., perception systems), such as LiDARs, cameras, radars, etc. and one or more on-board computers storing instructions for such identification and classification.

Conventional and automated vehicles navigate operational environments that tend to be pattern rich. The environments are structured according to recurring patterns recognizable by human drivers and autonomy systems that operate automated vehicles. For example, stop signs have standardized shapes and colors, and stop lights typically have standardized arrangements of green, yellow, and red lights. These recognizable patterns often require or elicit predictable behaviors by drivers or autonomy systems operating the vehicles in the environment. One such pattern is used in lane indications, which may indicate lane boundaries intended to require particular behavior within the lane (e.g., maintaining a constant path with respect to the lane line, not crossing a solid lane line). Due to the lane lines' consistency, predictability, and ubiquity, the lane lines serve as a good basis for a lateral component localization functions executed by the autonomy system, allowing the autonomy system to determine the automated vehicle's location.

The function of the perception aspect is to sense an environment surrounding the automated vehicle by gathering and interpreting sensor data. To interpret the surrounding environment, a perception module or engine in the autonomy system may identify and classify objects or groups of objects in the environment. For example, a perception module associated with various sensors (e.g., LiDAR, camera, radar, etc.) of the autonomy system may identify one or more objects (e.g., pedestrians, vehicles, debris, etc.) and features of a roadway (e.g., lane lines) around the automated vehicle, and classify the objects in the road distinctly.

The maps/localization aspect (sometimes referred to as a “map localizer”) of the autonomy system executes map localization functions (sometimes referred to as “MapLoc” functions). The map localization functions determine the current location of the automated vehicle within a pre-established and pre-stored digital map. A technique for map localization is to sense the environment surrounding the automated vehicle (e.g., via the perception system) and to correlate features of the sensed environment with details (e.g., digital representations of the features of the sensed environment) on the digital map. After the systems of the autonomy system have determined the location of the automated vehicle with respect to the digital map features (e.g., location on the roadway, upcoming intersections, road signs), the automated vehicle can plan and execute maneuvers and/or routes with respect to the features of the digital map.

The behaviors, planning, and control aspects of the autonomy system to make decisions about how an automated vehicle should move or navigate through the environment to get to a calculated goal or destination. For instance, the behaviors, planning, and control components of the autonomy system consumes information from the perception engine and the maps/localization modules to know where the ego vehicle is relative to the surrounding environment and what other traffic actors are doing. The behaviors, planning, and control components may be responsible for decision-making to ensure, for example, the vehicle follows rules of the road and interacts with other aspects and features in the surrounding environment (e.g., other vehicles) in a manner that would be expected of, for example, a human driver. The behavior planning may achieve this using a number of tools including, for example, goal setting (e.g., local goals destination, global goal destination), implementation of one or more bounds, virtual obstacles, and using other tools.

The automated vehicle includes hardware and software components of an autonomy system having a map localizer. The autonomy system ingests, gathers, or otherwise obtains (e.g., receives, retrieves) various types of data, which the autonomy system feeds to the map localizer. The autonomy system applies the map localization operations on the gathered data to locate and navigate the automated vehicle. The gathered data may include live data from sensors and pre-stored data, stored in non-transitory data storage, such as a stored digital map. Using the gathered data, the map localizer applies the map localization to estimate the vehicle location within a mapped locale.

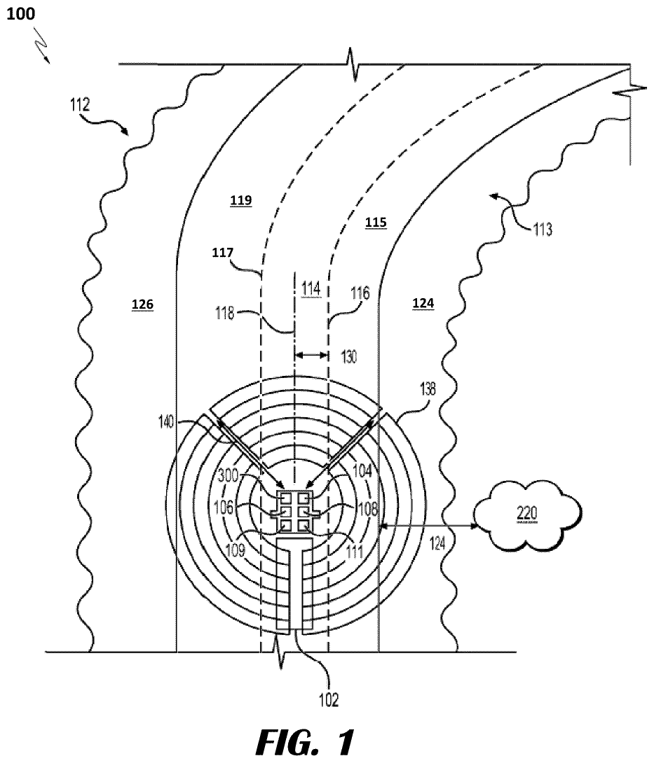

FIG. 1 illustrates a system 100 for localizing a vehicle 102. The vehicle 102 depicted in FIG. 1 is a truck (e.g., tractor trailer), but it is to be understood that the vehicle 102 could be any type of vehicle, such as a car or truck, among others. The vehicle 102 includes a controller 300 that is communicatively coupled to a camera system 104, a LiDAR system 106, a GNSS 108, a transceiver 109, and an inertial measurement unit 111 (IMU). The vehicle 102 may operate autonomously or semi-autonomously in any environment. As depicted, the vehicle 102 operates along a roadway 112 that includes a left shoulder, a right shoulder, and multiple lanes including a right lane 115, a left lane 119, and a center lane 114 that is bounded by a right-center lane marker 116 (lane indicator or lane indication) and bounded by a left-center lane marker 117. The right-center lane marker 116 and the left-center lane marker 117 are depicted as a dashed line in convention with the center lane markers in multi-lane roadways or highways in the United States, however, the lane markers could take any form (e.g., solid line). In the particular scenario depicted in FIG. 1, the vehicle 102 is approaching a right turn 113 (or right hand bend in the roadway 112), but any type of roadway or situation is considered herein. For example, the vehicle 102 could be on a road that continues straight, turns left, includes an exit ramp, approaches a stop sign or other traffic signal, etc.

The vehicle 102 has various physical features and/or aspects including a longitudinal centerline 118. As depicted in FIG. 1, the vehicle 102 generally progresses down the roadway 112 in a direction parallel to its longitudinal centerline 118. As the vehicle 102 drives down the roadway 112, it may capture LiDAR point cloud data and visual camera data (when referred to collectively, “image data”) using, for example, the LiDAR system 106 and the camera system 104, respectively. In some aspects, the vehicle 102 may also include other sensing systems (e.g., radar system). While it travels, the vehicle 102 may constantly, periodically, or on-demand determine its position and/or orientation with the GNSS 108 and/or the IMU 111. The vehicle 102 may be communicatively coupled with a network 220 via a wireless connection 124 using, for example, the transceiver 109.

As the vehicle 102 travels, the onboard systems and/or remote systems connected to the vehicle 102 may determine a lateral offset 130 from one or more features of the roadway 112. For example, in the particular embodiment depicted in FIG. 1, the vehicle 102 may calculate a lateral offset 130 from the right center lane marker 116. The lateral offset 130 may be, for example, a horizontal distance between the longitudinal centerline 118 of the vehicle 102 and the right center lane marker 116. However, these are merely two examples of features that could be used to calculate a vehicle offset. It is contemplated that any feature of the vehicle 102 (e.g., the right side, the left side, etc.) and any feature of the roadway 112 (e.g., the center lane left side marker 117, the right-lane right side marker 116, the edge of the right shoulder 124) could be used to calculate a lateral offset. In some embodiments, the lateral offset 130 may be used to localize the vehicle 102 as described in greater detail herein.

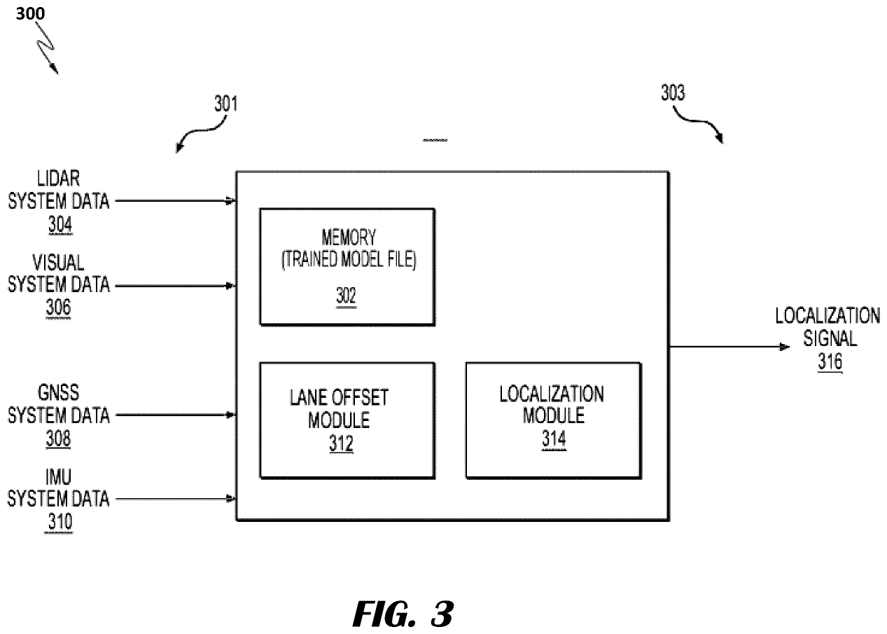

Still referring to FIG. 1, the controller 300, which is described in greater detail herein, especially with respect to FIG. 3, is configured to receive an input(s) and provide an output(s) to various other systems or components of the system 100. For example, the controller 300 may receive visual system data from the camera system 104, LiDAR system data from the LiDAR system 106, GNSS data from the GNSS 108, external system data from the transceiver 109, and IMU system data from the IMU 111.

The camera system 104 may be configured to capture images of the environment surrounding the vehicle 102 in a field of view (FOV) 138. Although depicted generally surrounding the vehicle 102, the FOV 138 can have any angle or aspect such that images of the areas ahead of, to the side, and behind the vehicle 102 may be captured. In some embodiments, the FOV 138 may surround 360 degrees of the vehicle 102. In some embodiments, the vehicle 102 includes multiple cameras and the images from each of the multiple cameras may be stitched to generate a visual representation of the FOV 138, which may be used to generate a birdseye view of the environment surrounding the vehicle 102, such as that depicted in FIG. 1. In some embodiments, the image file(s) generated by the camera system(s) 104 and sent to the controller 300 and other aspects of the system 100 may include the vehicle 102 or a generated representation of the vehicle 102. In some embodiments, the visual image generated from image data from the camera(s) 104 may appear generally as that depicted in FIG. 1 and show features depicted in FIG. 1 (e.g., lane markers, roadway) distinguished from other objects as pixels in an image. In some embodiments, one or more systems or components of the system 100 may overlay labels to the features depicted in the image data, such as on a raster layer or other semantic layer of an HD map. The camera system 104 may include one or more cameras with fields of view horizontally from the vehicle 102 for specific view of the lane indications (including, for example, the right center lane marker 116).

The LiDAR system 106 can send and receive a LiDAR signal 140. Although depicted generally forward, left, and right of the vehicle 102, the LiDAR signal 140 can be emitted and received from any direction such that LiDAR point clouds (or “LiDAR images”) of the areas ahead of, to the side, and behind the vehicle 102 can be captured. In some embodiments, the vehicle 102 includes multiple LiDAR sensors and the LiDAR point clouds from each of the multiple LiDAR sensors may be stitched to generate a LiDAR-based representation of the area covered by the LiDAR signal 140, which may be used to generate a bird's eye view of the environment surrounding the vehicle 102. In some embodiments, the LiDAR point cloud(s) generated by the LiDAR sensors and sent to the controller 300 and other aspects of the system 100 may include the vehicle 102. In some embodiments, a LiDAR point cloud generated by the LiDAR system 106 may appear generally as that depicted in FIG. 1 and show features depicted in FIG. 1 (e.g., lane markers, the roadway, etc.) distinguished from other objects as pixels in a LiDAR point cloud. In some embodiments, the system inputs from the camera system 104 and the LiDAR system 106 may be fused.

The GNSS 108 may be positioned on the vehicle 102 and may be configured to determine a location of the vehicle 102, which it may embody as GNSS data, as described herein, especially with respect to FIG. 3. The GNSS 108 may be configured to receive one or more signals from a global navigation satellite system (GNSS) (e.g., GPS system) to localize the vehicle 102 via geolocation. In some embodiments, the GNSS 108 may provide an input to or be configured to interact with, update, or otherwise utilize one or more digital maps, such as an HD map (e.g., in a raster layer or other semantic map). In some embodiments, the GNSS 108 is configured to receive updates from the external network 220 (e.g., via a GNSS/GPS receiver (not depicted), the transceiver 109, etc.) The updates may include one or more of position data, speed/direction data, traffic data, weather data, or other types of data about the vehicle 102 and its environment.

The transceiver 109 may be configured to communicate with the external network 220 via the wireless connection 124. The wireless connection 124 may be a wireless communication signal (e.g., Wi-Fi, cellular, LTE, 5g, etc.). However, in some embodiments, the transceiver 109 may be configured to communicate with the external network 220 via a wired connection, such as, for example, during testing or initial installation of the system 100 to the vehicle 102. The wireless connection 124 may be used to download and install various lines of code in the form of digital files (e.g., HD maps), executable programs (e.g., navigation programs), and other computer-readable code that may be used by the system 100 to navigate the vehicle 102 or otherwise operate the vehicle 102, either autonomously or semi-autonomously. The digital files, executable programs, and other computer readable code may be stored locally or remotely and may be routinely updated (e.g., automatically or manually) via the transceiver 109 or updated on demand. In some embodiments, the vehicle 102 may deploy with all of the data it needs to complete a mission (e.g., perception, localization, and mission planning) and may not utilize the wireless connection 124 while it is underway.

The IMU 111 may be an electronic device that measures and reports one or more features regarding the motion of the vehicle 102. For example, the IMU 111 may measure a velocity, acceleration, angular rate, and or an orientation of the vehicle 102 or one or more of its individual components using a combination of accelerometers, gyroscopes, and/or magnetometers. The IMU 111 may detect linear acceleration using one or more accelerometers and rotational rate using one or more gyroscopes. In some embodiments, the IMU 111 may be communicatively coupled to the GNSS 108 and may provide an input to and receive an output from the GNSS 108, which may allow the GNSS 108 to continue to predict a location of the vehicle 102 even when the GNSS cannot receive satellite signals.

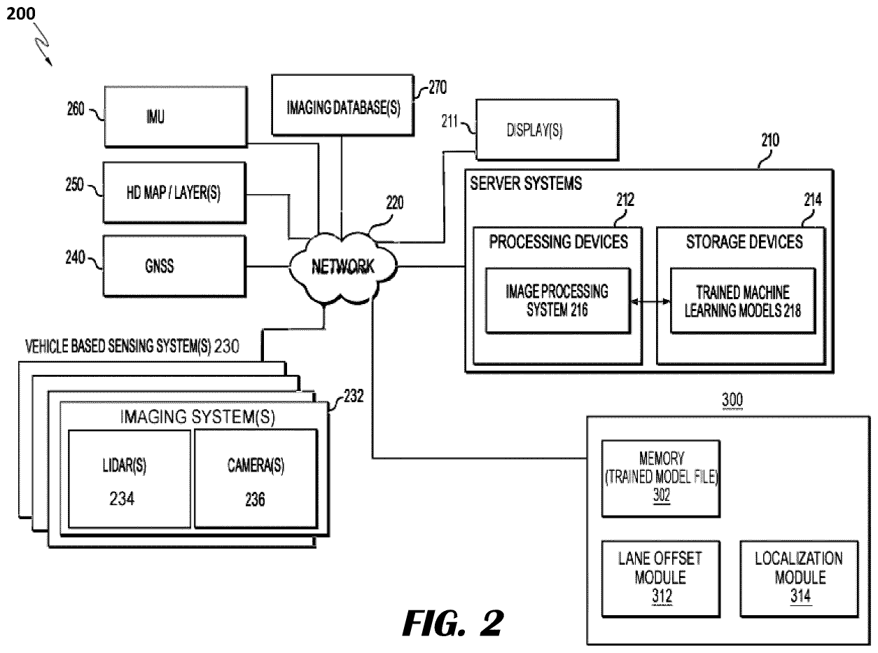

Referring now to FIG. 2, an exemplary environment 200 for generating and training machine learning models to predict a lane offset according to an exemplary process of the present disclosure is shown. FIG. 2 includes the environment 200 which may include the network 220 that communicatively couples one or more server systems 210, one or more vehicle based sensing systems 230 which may include one or more imaging systems 232 (e.g., LiDAR systems and/or camera systems), one or more GNSS systems 240, one or more HD map systems 250, one or more IMU systems 260, and one or more imaging databases 270. Additionally, the controller 300 of FIG. 1 and FIG. 3 may be communicatively coupled to the network 220 and may upload and download data from one or more of the other systems connected to the network 220 as described herein. In some embodiments, the exemplary environment may include one or more displays, such as the display 211, for displaying information.

The server systems 210 may include one or more processing devices 212 and one or more storage devices 214. The processing devices 212 may be configured to implement an image processing system 216. The image processing system 216 may apply AI, machine learning, and/or image processing techniques to image data received, e.g., from vehicle based sensing systems 230, which may include LiDAR(s) 234, camera(s) 236. Other vehicle based sensing systems are contemplated such as, for example, radar or ultrasonic sensing, among others. The vehicle based sensing systems 230 may be deployed on, for example, a fleet of vehicles such as the vehicle 102 of FIG. 1.

Still referring to FIG. 2, the image processing system 216 may include a training image platform configured to generate and train a plurality of trained machine learning models 218 based on datasets of training images received, e.g., from one or more imaging databases 270 over the network 120 and/or from the vehicle based sensing systems 230 on the fleet of vehicles. In some embodiments, data generated using the vehicle based sensing systems 230 may be used to populate the imaging databases 270. The training images may be, for example, images of vehicles operating on a roadway including one or more lane boundaries or lane features (e.g., a lane boundary line, a right roadway shoulder edge). The training images may be real images or synthetically generated images (e.g., to compensate for data sparsity, if needed). The training images received may be annotated e.g., using one or more of the known or future data annotation techniques, such as polygons, brushes/erasers, bounding boxes, keypoints, keypoint skeletons, lines, ellipses, cuboids, classification tags, attributes, instance/object tracking identifiers, free text, and/or directional vectors, in order to train any one or more of the known or future model types, such as image classifiers, video classifiers, image segmentation, object detection, object direction, instance segmentation, semantic segmentation, volumetric segmentation, composite objects, keypoint detection, keypoint mapping, 2-Dimension/3-Dimension and 6 degrees-of-freedom object poses, pose estimation, regressor networks, ellipsoid regression, 3D cuboid estimation, optical character recognition, text detection, and/or artifact detection.

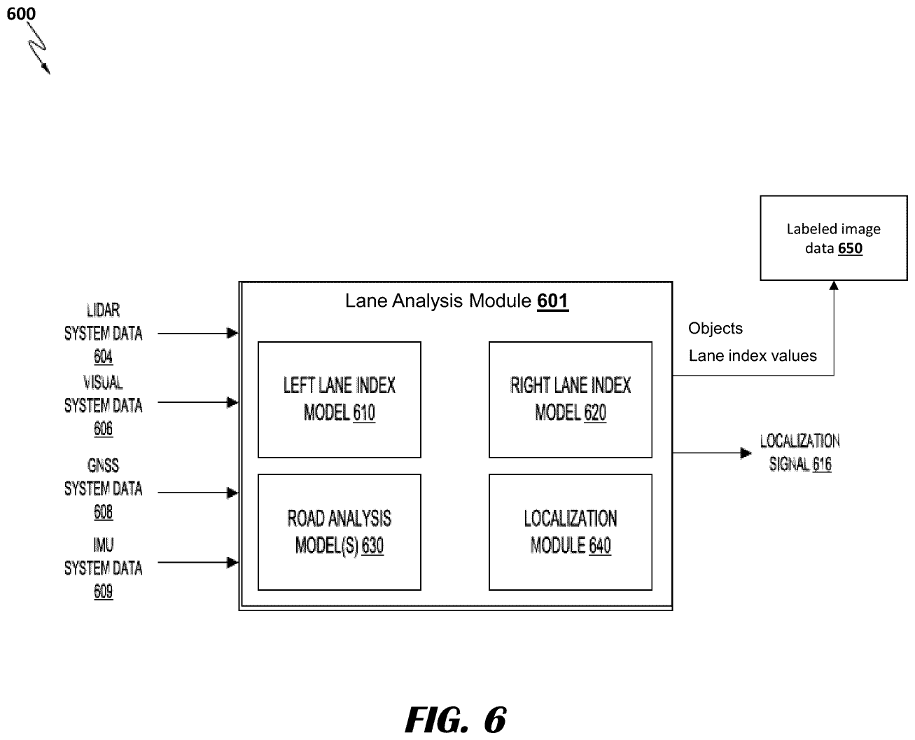

The trained machine learning models 218 may include convolutional neural networks (CNNs), support vector machines (SVMs), generative adversarial networks (GANs), and/or other similar types of models that are trained using supervised, unsupervised, and/or reinforcement learning techniques. For example, as used herein, a “machine learning model” generally encompasses instructions, data, and/or a model configured to receive input, and apply one or more of a weight, bias, classification, or analysis on the input to generate an output. The output may include, e.g., a classification of the input, an analysis based on the input, a design, process, prediction, or recommendation associated with the input, or any other suitable type of output. A machine learning system or model may be trained using training data, e.g., experiential data and/or samples of input data, which are fed into the system in order to establish, tune, or modify one or more aspects of the system, e.g., the weights, biases, criteria for forming classifications or clusters, or the like. The training data may be generated, received, and/or otherwise obtained from internal or external resources. Aspects of a machine learning system may operate on an input linearly, in parallel, via a network (e.g., a neural network), or via any suitable configuration. The trained machine learning models 218 may include the left lane index model 610, the right lane index model 620, and the one or more road analysis model(s) 630 described in connection with FIG. 6.

The execution of the machine learning system may include deployment of one or more machine learning techniques, such as linear regression, logistical regression, random forest, gradient boosted machine (GBM), deep learning, and/or a deep neural network (e.g., multi-layer perceptron (MLP), CNN, recurrent neural network). Supervised and/or unsupervised training may be employed. For example, supervised learning may include providing training data and labels corresponding to the training data, e.g., as ground truth. Training data may comprise images annotated by human technicians (e.g., engineers, drivers, etc.) and/or other automated vehicle professionals. Unsupervised approaches may include clustering, classification, or the like. The machine-learning architecture may also use K-means clustering or K-Nearest Neighbors, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc. Alternatively, reinforcement learning may be employed for training. For example, reinforcement learning may include training an agent interacting with an environment to make a decision based on the current state of the environment, receive feedback (e.g., a positive or negative reward based on accuracy of decision), adjusts its decision to maximize the reward, and repeat again until a loss function is optimized.

The trained machine learning models 218 may be stored by the storage device 214 to allow subsequent retrieval and use by the system 210, e.g., when an image is received for processing by the vehicle 102 of FIG. 1. In other techniques, a third party system may generate and train the plurality of trained machine learning models 218. The server systems 210 may send and/or receive trained machine learning models 218 from the third party system and store within the storage devices 214. In some examples, the images generated by the imaging systems 232 may be transmitted over the network 220 to the imaging databases 270 or to the server systems 210 for use as training image data. In some embodiments, the trained machine learning models 218 may be trained to generate a trained model file which may be sent, for example, to a memory 302 of the controller 300 and used by the vehicle 102 to localize the vehicle 102 as described in greater detail herein. In some implementations, the left lane index model 610, the right lane index model 620, and the one or more road analysis model(s) 630 described in connection with FIG. 6 may be transmitted to the controller 300, which may implement the lane analysis module 600.

The network 220 over which the one or more components of the environment 200 communicate may be a remote electronic network and may include one or more wired and/or wireless networks, such as a wide area network (“WAN”), a local area network (“LAN”), personal area network (“PAN”), a cellular network (e.g., a 3G network, a 4G network, a 5G network, etc.) or the like. In one technique, the network 120 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The server systems 210, imaging systems 230, GNSS 240, HD Map 250, and IMU 260, and/or imaging databases 270 may be connected via the network 120, using one or more standard communication protocols. In some embodiments, the vehicle 102 (FIG. 1) may be communicatively coupled (e.g., via the controller 300) with the network 220.

The GNSS 240 may be communicatively coupled to the network 220 and may provide highly accurate location data to the server systems 210 for one or more of the vehicles in a fleet of vehicles. The GNSS signal received from the GNSS 240 of each of the vehicles may be used to localize the individual vehicle on which the GNSS receiver is positioned. The GNSS 240 may generate location data which may be associated with a positon from which particular image data is captured (e.g., a location at which an image is captured) and, in some embodiments, may be considered a ground truth position for the image data. In some embodiments, image data captured by the one or more vehicles in the fleet of vehicles may be associated with (e.g., stamped) with data from the GNSS 240 which may relate the image data to an orientation, a velocity, a position, or other aspect of the vehicle capturing the image data. In some embodiments, the GNSS 240 may be used to associate location data with image data such that a subset of the trained model file can be generated based on the capture location of a particular set of image data to generate a location-specific trained model file.

In some embodiments, the HD map 250, including one or more layers, may provide an input to or receive an input from one or more of the systems or components connected to the network 220. For example, the HD map 250 may provide raster map data as an input to the server systems 210 which may include data categorizing or otherwise identifying portions, features, or aspects of a vehicle lane (e.g., the lane markings of FIG. 1) or other features of the environment surrounding a vehicle (e.g., stop signs, intersections, street names, etc.)

The IMU 260 may be an electronic device that measures and reports one or more of a specific force, angular rate, and/or the orientation of a vehicle (e.g., vehicle 102 of FIG. 1) using a combination of accelerometers, gyroscopes, and/or magnetometers. The IMU 260 may be communicatively coupled to the network 220 and may provide dead reckoning position data or other position, orientation, or movement data associated with one or more vehicles in the fleet of vehicles. In some embodiments, image data captured by the one or more vehicles in the fleet of vehicles may be associated with (e.g., stamped) with data from the IMU 260 which may relate the image data to a position, orientation, or velocity of the vehicle capturing the data. In some embodiments, data from the IMU 260 may be used in parallel with or in place of GNSS data from the GNSS 240 (e.g., when a vehicle captures image data from inside a tunnel where no GNSS signal is capable).

Referring now to FIG. 3, the controller 300 is depicted in greater detail. The controller 300 executes various software programming functions of an autonomy system of an automated vehicle, in which the components of the autonomy system may receive inputs 301 and generate outputs 303 by performing various processes for analyzing the inputs 301 related to an environment or other types of data and determining how to operate the automated vehicle. The controller 300 may include a memory 302, a lane offset module 312, and a localization module 314. The inputs 301 may include LiDAR system data 304, visual system data 306, GNSS system data 308, and IMU system data 310. The outputs 303 may include a localization signal 316. The memory 302 may include a trained model file, which may have been trained, for example, by the machine learning models 218 of FIG. 2.

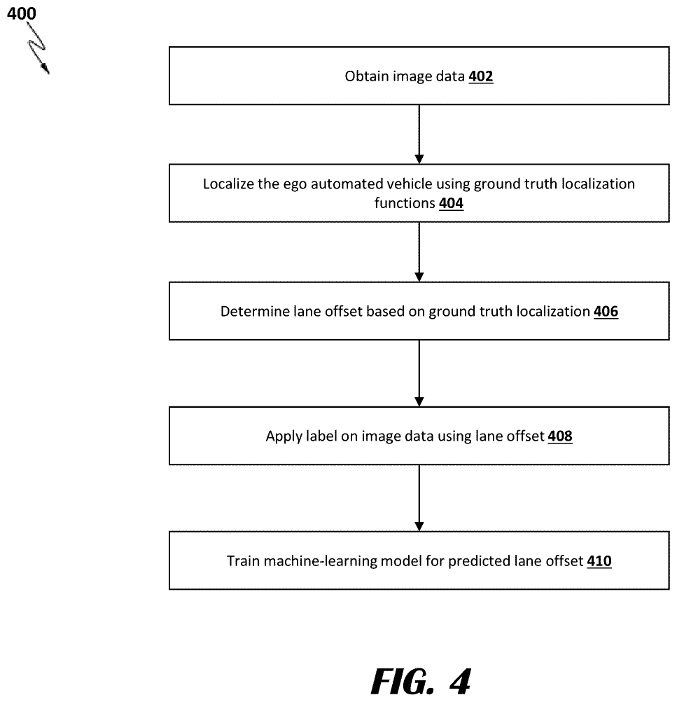

The controller 300 may comprise a data processor, a microcontroller, a microprocessor, a digital signal processor, a logic circuit, a programmable logic array, or one or more other devices for controlling the system 100 in response to one or more of the inputs 301. Controller 300 may embody a single microprocessor or multiple microprocessors that may include means for automatically generating a localization of the vehicle 102. For example, the controller 300 may include a memory, a secondary storage device, and a processor, such as a central processing unit or any other means for accomplishing a task consistent with the present disclosure. The memory or secondary storage device associated with controller 300 may store data and/or software routines that may assist the controller 300 in performing its functions, such as the functions of an example process 400 described herein with respect to FIG. 4.

Further, the memory or secondary storage device associated with the controller 300 may also store data received from various inputs associated with the system 100. Numerous commercially available microprocessors can be configured to perform the functions of the controller 300. It should be appreciated that controller 300 could readily embody a general machine controller capable of controlling numerous other machine functions. Alternatively, a special-purpose machine controller could be provided. Further, the controller 300, or portions thereof, may be located remote from the system 100. Various other known circuits may be associated with the controller 300, including signal-conditioning circuitry, communication circuitry, hydraulic or other actuation circuitry, and other appropriate circuitry.

The memory 302 may store software-based components to perform various processes and techniques described herein of the controller 300, including the lane offset module 312, and the localization module 314. The memory 302 may store one or more machine readable and executable software instructions, software code, or executable computer programs, which may be executed by a processor of the controller 300. The software instructions may be further embodied in one or more routines, subroutines, or modules and may utilize various auxiliary libraries and input/output functions to communicate with other equipment, modules, or aspects of the system 100. In some implementations, the localization module 314 may implement any of the functionality of the localization module 640 described in connection with FIG. 6, or vice versa.

As mentioned above, the memory 302 may store a trained model file(s) that may serve as an input to one or more of the lane offset module 312 and/or the localization module 314. The trained model file(s) may be stored locally on the vehicle such that the vehicle need not receive updates when on a mission. The trained model files may be machine-trained files that include associations between historical image data and historical lane offset data associated with the historical image data. The trained model file may contain trained lane offset data that may have been trained by one or more machine-learning models having been configured to learn associations between the historical image data and the historical lane offset data as will be described in greater detail herein. In some embodiments, the trained model file may be specific to a particular region or jurisdiction and may be trained specifically on that region or jurisdiction. For example, in jurisdictions in which a lane indication has particular features (e.g., a given length, width, color, etc.) the trained model file may be trained on training data including only those features. The features and aspects used to determine which training images to train a model file may be based on, for example, location data as determined by the GNSS system 108, for example.

The lane offset module 312 may generate a lane offset of the vehicle 102 within a given lane. The lane offset may be an indication of the vehicle's lateral position within the lane and may be used (e.g., combined with a longitudinal position) to generate a localization of the vehicle 102 (e.g., a lateral and longitudinal positon with respect to the roadway 112). In an embodiment, the lane offset module 312 or the controller 300 may execute the lane analysis module 600 to generate one or more lane indices based on data captured during operation of the automated vehicle. For example, the left lane index model 610 and the right lane index model 620 may be executed to generate the left and right lane indices, respectively, of the lane in which the automated vehicle is traveling, as described herein.

The lane offset module 312 may be configured to generate and/or receive, for example, one or more trained model files in order to generate a lane offset that may then be used, along with other data (e.g., LiDAR system data 304, visual system data 306, GNSS system data 308, IMU system data 310, and/or the trained model file) by the localization module 314 to localize the vehicle 102 as described in greater detail herein.

The disclosed aspects of the system 100 of the present disclosure may be used to localize an ego vehicle, such as the vehicle 102 of FIG. 1. More specifically, the ego vehicle may be localized based on a conversion of obtained image data into image feature data, which may then be computed, using one or more trained machine learning models, as lane offset data which may correspond to the image data. Additionally, the left lane index model 610, the right lane index model 620, and the one or more road analysis models 630 of FIG. 6 can be executed to determine lane index information or other lane characteristics using the obtained image data, as described herein.

FIG. 4 depicts operations of a process 400 for handling image data gathered by an automated vehicle, according to an embodiment. It should be appreciated that other embodiments may comprise additional or alternative execution operations, or may omit one or more operations altogether. It should also be appreciated that other embodiments may perform certain execution operations in a different order. Operations discussed herein may also be performed simultaneously or near-simultaneously with one another.

In operation 402, an autonomy system of the automated vehicle obtains (e.g., retrieves or receives) image data related to an operating environment. The autonomy system may obtains the image data from various data sources, including one or more cameras or other types of optical sensors of the automated vehicle, a local or remote database hosted on non-transitory machine readable memory and containing the image data, or from a fleet of vehicles operating in the same or similar operating environment, such as the physical environment depicted in FIG. 1 (e.g., highway). The image data includes digital media representing visual imagery of the environment, such as features, objects, or other aspects of the environment of the roadway (e.g., image data capturing the lane lines and other features in the environment). In some cases, the autonomy system (or component thereof) applies one or more filters (e.g., Kalman filter, low-pass filter) on the image data in order to prepare the image data for processing.

In some implementations, a fleet of vehicles or other systems equipped with imaging and other sensing systems (e.g., cameras, LiDARs, radars) generates the image data. These other vehicles may upload the image data for storage in a database accessible to the automated vehicle (e.g., imaging database 270 of FIG. 2) or transmit the image data to the automated vehicle. The sensor devices of the fleet vehicles may be configured to periodically capture image data (e.g., on a duty cycle) and the period could be set to any value (e.g., 20% of the time, 50% of the time, 100% of the time). In some cases, the period could be based on a number of miles driven (e.g., capture image data every 100^{th} mile for ten miles, etc.) or be location based (e.g., capture data for a geographic location in which data has not been captured to the desired level). The fleet vehicles may collect the image data any number of miles driven (e.g., in the millions of miles driven) and may be stored, for example, into the database.

The autonomy system executes any number of machine-learning architecture functions that, for example, recognize features or objects in the environment and prepare downstream operating instructions. The autonomy system may execute a classifier configured to classify objects, features, or attributes of the environment based on one or more factors, such as, for example, type of object, type of vehicle, traffic density at the time of capture (e.g., normal, crowded, etc.), and may be associated with a particular geographic location (e.g., southwest United States, greater Phoenix, U.S. Interstate No. 40).

In some embodiments, an operator or other person may input labels to the image data in order to label the image data for inclusion in a training dataset for training the machine-learning architecture.

The autonomy system (or object recognition engine component of the autonomy system) may perform feature extraction on the obtained images, for example, using a convolutional neural network (CNN) to determine the presence of a lane line in the image data. CNN's may provide strong feature extraction capabilities and, in some implementations, the CNN may utilize one or more convolution processes or operations, such as a parallel spatial separation convolution, to reduce network complexity and may use height-wise and/or width-wise convolution to extract underlying features of the image data. The CNN may also use height-wise and width-wise convolutions to enrich detailed features and in some embodiments, may use one or more channel-weighted feature merging strategies to merge features. The feature extraction techniques may assist with classification efficiency. In some embodiments, the training data may be augmented using, for example, random rescaling, horizontal flips, perturbations to brightness, contrast, and color, as well as random cropping.

At operation 404, the one or more vehicles in the fleet of vehicles may localize using a ground truth location source (e.g., highly accurate GNSS). The ground truth localization may include a relative and/or absolute position (e.g., GPS coordinates, latitude/longitude coordinates, etc.) and may be obtained separately or contemporaneously with the image data. In some embodiments, portions of the ground truth localization data may represent the ground truth location of the vehicle capturing the image data at the time the image was captured. For example, the cameras or LiDAR of the automated vehicle may capture an image having one or more features of the surrounding environment having lanes, lane markers (e.g., right-center lane marker, left-center lane marker). Contemporaneously, a GNSS device of the autonomy system may capture highly accurate GNSS data from a GNSS data service. In some cases, the image data may be labeled with the highly accurate location data. In some cases, the autonomy system may apply a confidence to one or more of the ground truth information sources and the ground truth information sources may be selected based on the applied confidence. In some cases, the autonomy system may apply one or more object recognition engines of the machine-learning architecture on the image data to recognize (and classify) the objects or other aspects of the environment.

At operation 406, the autonomy system determines a lane offset of the automated vehicle based on the image data and the ground truth localization. The lane offset may be a unidimensional distance from a feature of the vehicle (e.g., longitudinal centerline 118) to a visible and distinguishable feature of the image data (e.g., right-center lane marker 116). The autonomy system may measure the lane offset in any distance unit (e.g., feet, meters) and may be expressed as an absolute value (e.g., “two feet from the right-center lane marker 116”) or as a difference from the centerline or some other reference point associated with the lane (e.g., “+/−0.2 meters from the centerline 118”).

To determine the lane offset of the ego vehicle, the autonomy system may use one or more localization solution sources. For example, the system may use a mature map localization solution run in real time, online on the automated vehicle. The autonomy system may use post-process kinematics (PPK) correction from a GPS signal (e.g., as received through the GNSS device 108). The autonomy system may use a real-time kinematic correction from the GPS signal (e.g., as received through the GNSS device 108).

At operation 408, the vehicle 102 or other component of the environment 200 may label the image data generated by the imaging systems of the vehicle 102 with the lane offset values determined based on the ground truth localization. The ground truth localization may be based on, for example, mature and verified map-localization solutions. Labeling the image data with the ground truth lane offset may generate ground truth lane offset image data, which may be used as ground truth data to, for example, train one or more machine learning models to predict a lane offset based on real time image data captured by an ego vehicle.

At operation 410, a machine learning model for predicting a lane offset may be generated and trained. For example, lane offset image data may be input to the machine learning model. The machine learning model may be of any of the example types listed previously herein. With brief reference to FIG. 1, the machine learning model may predict, for example, a lane offset 130 from the longitudinal centerline 118 of the vehicle 102 to the right center lane marker 116 of the center lane 114. In some embodiments, the predicted lane offset may be based on the labeled image data generated to include the ground truth location data. In embodiments in which the lane offset is predicted, the lane offset may be predicted in addition to or in lieu of a ground truth location as determined by another system of the vehicle 102 (e.g., the GNSS 108, the IMU 111, etc.)

To train the machine learning model, the predicted lane offset output by the machine learning model for given image data may be compared to the label corresponding to the ground truth location to determine a loss or error. For example, a predicted lane offset for a first training image may be compared to a known location within the first training image identified by the corresponding label. The machine learning model may be modified or altered (e.g., weights and/or bias may be adjusted) based on the error to improve the accuracy of the machine learning model. This process may be repeated for each training image or at least until a determined loss or error is below a predefined threshold. In some examples, at least a portion of the training images and corresponding labels (e.g., ground truth location) may be withheld and used to further validate or test the trained machine learning model.

When the autonomy system determines that the machine-learning model is sufficiently trained, the autonomy system may store the trained machine-learning model into the local or remote database for subsequent use (e.g., as one of trained machine-learning models 218 stored in storage devices 214). In some cases, the trained machine-learning model may be a single machine learning model that is generated and trained to predict lane offset(s). In some cases, the exemplary process 400 may be performed to generate and train an ensemble of machine learning models, where each model predicts a lane offset. When deployed to evaluate image data generated by an ego vehicle, the ensemble of machine learning models may be run separately or in parallel.

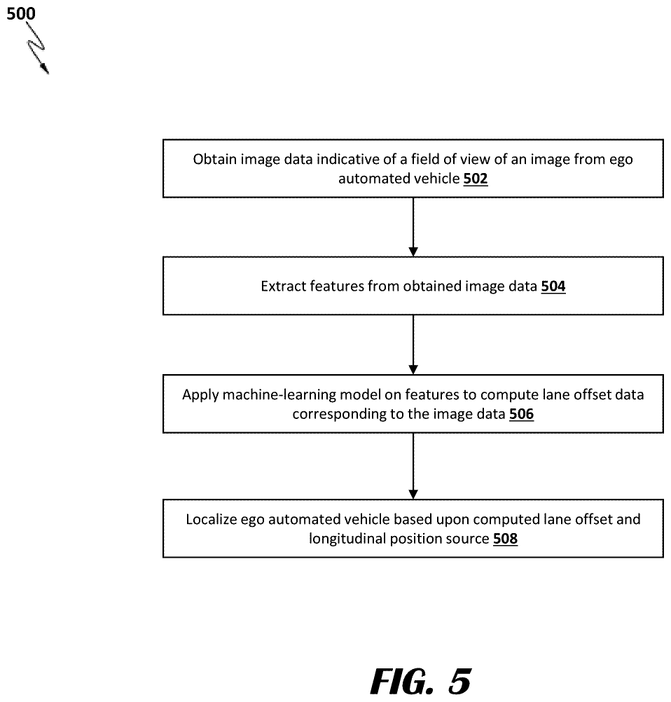

FIG. 5 shows operations of a process 500 for localizing an ego vehicle, according to an embodiment. The process 500 is performed by an autonomy system of an ego automated vehicle, though processes and features of the process 500 may be performed by various devices and software components onboard the automated vehicle or in remote communication with the autonomy system of the automated vehicle. It should be appreciated that other embodiments may comprise additional or alternative execution operations, or may omit one or more operations altogether. It should also be appreciated that other embodiments may perform certain execution operations in a different order. Operations discussed herein may also be performed simultaneously or near-simultaneously with one another.

At operation 502, the autonomy system of the automated vehicle obtains image data which is indicative of a field of view. For example, with reference to FIG. 1, the vehicle 102 may obtain image data from the environment surrounding the vehicle 102. The autonomy system may obtain the image data in any perspective (e.g., 360 degree field of view) based on the orientation, position, and field of view of the individual sensing or imaging devices (e.g., camera, LiDAR, radar) onboard the automated vehicle. The image data may include LiDAR system data and visual system data. In some embodiments, the autonomy system may stitch and/or fuse the LiDAR system data and the visual system data together to generate a hybrid image as the image data. In some cases, the obtained image data may include only one of either LiDAR or visual system data. The LiDAR/visual hybrid image may indicate the various features in the environment as depicted in FIG. 1. The LiDAR and visual image systems may provide metadata and generate image data having sufficient resolution that an object recognition engine may detect and classify each of the physical features, objects, and/or other aspects. In some embodiments, a user (e.g., an onboard passenger, a remote operator, etc.) may select one or more LiDAR systems or camera systems with which the vehicle 102 may capture image. For example, on vehicles including one or more LiDAR systems and/or camera systems, the user may select which system to use (e.g., use the right-side facing camera to capture image data).

At operation 504, the autonomy system may extract one or more features from the obtained image data. The image data may be, for example, preprocessed using computer vision functions that process, load, transform, and manipulate image data for building an ideal dataset for a machine learning algorithm (e.g., classifier). The autonomy system may convert the image data into one or more similar formats. Various unnecessary regions, features, or other portions of the image data may be cropped, tagged, or otherwise handled from the image data. For instance, the autonomy system may apply particular labels or bounding boxes to objects or other portions of the image data.

In some embodiments, the autonomy system may center the obtained image data from various sensors based on one or more feature pixels by, for example, subtracting the per-channel mean pixel values calculated on the training dataset.

At operation 506, the autonomy system may compute, using a trained machine learning model, lane offset data corresponding to the image data. The lane offset data may represent a unidimensional length from a centerline of the longitudinal axis of the automated vehicle to the edge of some feature of the roadway. For example, the lane offset data may represent a unidimensional distance from the longitudinal axis of the automated vehicle to a right center lane marker, but the lane offset could be from any portion of the automated vehicle (e.g., axis along the right or left side of the vehicle 102) to any feature of the roadway (e.g., right shoulder 124). The lane offset module may access and execute, for example, a trained model file, which may be stored in a local or remote non-transitory memory, to calculate the lane offset.

A lane offset module of the autonomy system may use machine-learning model to compute the lane offset. The lane offset (generated at operation 508) may be a prediction of a lane offset based on a machine-learning model applied to the image data captured by one or more of the LiDAR sensors and/or the cameras. The autonomy system may generate the prediction according to a high level of accuracy based on a pre-stored “corpus” of image data in a non-transitory memory hosting an image database, used to generate the trained model files, where image data is collect by, for example, the automated vehicle or fleet of vehicles.

At operation 508, the autonomy system may localize the automated vehicle by correlating the lane offset of the automated vehicle (generated at operation 506) with longitudinal position data using, for example, a localization module of the autonomy system. The longitudinal position data may be generated based on one or more of, for example, the GNSS system data and the IMU system data. In this way, the automated vehicle may have a highly accurate lateral position based on the lane offset and an accurate, longitudinal position based on the GNSS and the IMU. In addition, the automated vehicle generates or otherwise determines both a lateral and longitudinal position of the automated vehicle within the lane.

For example, the lane offset module may generate a unidimensional position indication of the automated vehicle within the lane based on a distance from an aspect of the automated vehicle (e.g., the centerline 118) and a lane indication (e.g., the center lane right side marker 116). For example, the unidimensional position indication may indicate 1.7 meters from the automated vehicle centerline to a center lane right side marker. The localization could be presented in any usable format, such as, for example, “15 cm right of center,” “+/−15 cm,” etc. The longitudinal position may come from the GNSS system via a GNSS device and/or an IMU. Having both a highly accurate lateral position and a longitudinal position, the autonomy system localizes the automated vehicle within the lane and may plot the location and position on an image data of an HD map or other semantic map, using, for example, a localization signal to localize the automated vehicle.

FIG. 6 is a block diagram of showing data flow amongst components of an autonomy system 600, including executable programming of one or more machine-learning models for a lane analysis module 601, according to an embodiment. The lane analysis module 601 generates lane indices for lanes of a roadway. The lane analysis module 601 includes a left lane index model 610, a right lane index model 620, one or more road analysis models 630, and a localization module 640. Inputs to the lane analysis module 601 may include LiDAR system data 604, visual system data 606, GNSS system data 608, and IMU system data 609. Outputs of the lane analysis module 601 may include a localization signal 616, lane index values, recognized objects and labeled image data 650. The autonomy system 600 references the lane index outputs of the lane analysis module 601 to determine the particular lane (or shoulder) containing the recognized objects, and generate metadata labels or database entries for the recognized objects, indicating the particular lane containing the object, thereby generating the labeled image data 650 that associates the recognized objects with the corresponding lanes.

In some embodiments, each of the LiDAR system data 604, the visual system data 606, the GNSS system data 608, and the IMU system data 609 may be similar to the LiDAR system data 304, the visual system data 306, the GNSS system data 308, and the IMU system data 310 described in connection with FIG. 3. The inputs to the lane analysis module 601 may be captured, for example, using one or more of the sensors of the automated vehicle described herein (e.g., the imaging system 232, the IMU 260, the GNSS 240, etc.). The components of the autonomy system 600 may be executed by one or more processors of the automated vehicle, such as a controller or similar processor. The lane analysis module 601 may be a part of, or may implement any of the structure or functionality of a lane offset module and/or a localization module. For example, the lane analysis module 601 may be executed to calculate lane index values, as described herein, in addition lane offset values. The outputs of the lane analysis module 601 may be provided, for example, to localize the automated vehicle corresponding to the lane analysis module 600 or for assigning lane index values to objects recognized by applying the object recognition engine 603 on the image data received in the visual system data 606.

Each of the left lane index model 610 and the right lane index model 620 may be neural network models that include a number of machine learning layers of the machine-learning architecture. In an embodiment, the left lane index model 610 and the right lane index model 620 may have a similar or identical architecture (e.g., number and type of layers), but may be trained to generate different values (e.g., using different ground truth data). Each of the left lane index model 610 and the right lane index model 620 may include one or more feature extraction layers, which may include convolutional layers or other types of neural network layers (e.g., pooling layers, activation layers, normalization layers, etc.). Each the left lane index model 610 and the right lane index model 620 can include one or more classification layers (e.g., fully connected layers, etc.) that can output a classification of the relative lane index. In some embodiments, the left lane index model 610 and the right lane index model 620 are trained to identify and classify shoulder lanes of the roadway. In some embodiments, the lane analysis module 601 includes a distinct right hand shoulder model (not shown) and left hand shoulder model (not shown).

Each of the left lane index model 610 and the right lane index model 620 can be trained to receive image data as input and generate a corresponding lane index value as output. The image data can include any type of image data described herein, including the LiDAR system data 604 (e.g., LiDAR images or point clouds, etc.) and the visual system data 606 (e.g., images or video frames captured by cameras of the automated vehicle). The lane index value can be an index referencing the lane that the respective machine-learning model (e.g., the left lane index model 610 or the right lane index model 620) determines that the automated vehicle is or an object is positioned in when the input image data was captured.

In some embodiments, the models of the lane analysis module 601 are trained to generate lane index values to include absolute values for the lanes. For example, in a highway with four lanes of directional travel, a leftmost lane is assigned an index value of zero (0) and a rightmost lane is assigned an index value of three (3). The shoulders may be indexed separately with special designations (e.g., S1 and S2). Alternatively, the shoulders may be indexed as additional lanes. For example, in a highway with four lanes of directional travel, a left shoulder is assigned an index value of zero (0), a leftmost lane is assigned an index value of one (1), a rightmost lane is assigned an index value of four (4), and the right shoulder is assigned an index of (5). Additionally or alternatively, in some embodiments, the models of the lane analysis module 601 are trained to generate the lane index values to include relative values, relative to the current lane of travel of the automated vehicle. For example, when the automated vehicle travels in a second-to-rightmost lane of a highway with four lanes of directional travel, the current lane is assigned an index value of zero (0), the rightmost lane is assigned the index value of one (+1), the leftmost lane is assigned the index value of negative two (−2), and the adjacent left lane is assigned an index value of negative one (−1). As before, the shoulders may be assigned index values consistent with the indexing scheme or assigned special shoulder designations.

In some embodiments, the left lane index model 610 can be trained to generate a left lane index value that is relative to the leftmost lane, and the right lane index model 620 can be trained to generate a right lane index value that is relative to the rightmost lane. In a non-limiting example, the rightmost lane of a four lane highway may have a right lane index value of one, and a left lane index value of four. The leftmost lane of the four lane high can have a right lane index value of four, and a left lane index value of one. The middle-right lane of the four lane highway can have a right lane index value of two, and a left lane index value of three. The middle-left lane of the four-lane highway can have a right lane index value of three, and a left lane index value of two.

Each of the left lane index model 610 and the right lane index model 620 may be trained as part of the machine learning models described herein (e.g., machine-learning models 218). The left lane index model 610 and the right lane index model 620 can be trained by one or more computing systems or servers, such as the server systems 210, as described herein, and/or by the processors (e.g., controller 300) executing the autonomy system 600. The left lane index model 610 and the right lane index model 620 may be trained using supervised and/or unsupervised training techniques. For example, using a supervised learning approach, the left lane index model 610 and the right lane index model 620 may be trained using provided training data and training labels corresponding to the training data (e.g., as ground truth). The training data may include a respective label for each of left lane index model 610 and the right lane index model 620 for a given input image. During training, both the left lane index model 610 and the right lane index model 620 may be provided with the same input data, but may be trained using different and respective labels.

During training, input image data can be propagated through each layer of the left lane index model 610 and the right lane index model 620 until respective output values are generated. The output values can be utilized with the respective left and right ground truth labels associated with the input image data to calculate loss values for the left lane index model 610 and the right lane index model 620. Some non-limiting example loss functions used to calculate the loss values include mean squared error, cross-entropy, and hinge loss. The trainable parameters of the left lane index model 610 and the right lane index model 620 can then be modified according to their respective loss values using a backpropagation technique (e.g., gradient descent or another type of optimizer, etc.) to minimize the loss values. The left lane index model 610 and the right lane index model 620 can be iteratively trained until a training termination condition (e.g., a maximum number of iterations, a performance threshold determined using a validation dataset, a rate of change in model parameters falling below a threshold) has been reached. After training, the left lane index model 610 and the right lane index model 620 can be provided to the lane analysis module 600 of the automated vehicle (e.g., the vehicle 102) via a network (e.g., the network 220) or another communications interface.

The autonomy system 600 executes the left lane index model 610 and the right lane index model 620 using data sensor data (e.g., LiDAR system data 604, the visual system data 606) captured by the sensors of the automated vehicle as the automated vehicle operates on a roadway. The lane analysis module 600 can execute each of the left lane index model 610 and the right lane index model 620 by propagating the input data through the left lane index model 610 and the right lane index model 620 to generate a left lane index value and a right lane index value. The left lane index value can represent the index of the lane in which the automated vehicle is traveling relative to the leftmost lane, and the right lane index value can represent the index of the lane in which the automated vehicle is traveling relative to the rightmost lane. The lane analysis module 601 need not output both a right lane index value and left lane index value. For instance, the lane analysis module 601 could output only a right lane index value or left lane index value for the lanes.

In some implementations, the lane analysis module 601 can perform error checking on the left lane index value and the right lane index value. For example, if the left lane index value determines (e.g., based on a determined number of lanes in the roadway from a predefined map or from an output of the road analysis models 630) that the left lane index value does not agree with the right lane index value, the lane analysis module 601 may generate an error message in a log or other error file.

The generated left lane index value and the right lane index value can be provided to the localization module 640 (e.g., localization module 314). The localization module 640 can utilize the left lane index value and the right lane index value, along with any other input data of the lane analysis module (e.g., LiDAR system data 604, visual system data 606, GNSS system data 608, IMU system data 609) to localize the automated vehicle. For example, the localization module 640 can localize the automated vehicle by correlating the lane index values (and in some embodiments, the lane offset values generated by the lane offset module as described herein) with longitudinal position data using, for example, the localization module. The longitudinal position data may be generated based on one or more of, for example, the GNSS system data 608 and the IMU system data 609. Localizing the automated vehicle can include generating an accurate lateral position based on the lane index and/or offset and an accurate, longitudinal position based on the GNSS and the IMU. To localize the automated vehicle, the localization module may perform described in connection with, for example, operation 508 of FIG. 5.

The road analysis models 630 include various types of machine learning or artificial intelligence model (e.g., a neural network, a CNN, a regression model) for identifying or navigating aspects of the operational environment. The analysis models 630 may be trained to receive any of the input data of the lane analysis module 601 (e.g., the LiDAR system data 604, the visual system data 606, the GNSS system data 608, and the IMU system data 609) as input, and to generate various characteristics of the roadway as output. For instance, the one or more road analysis models 630 may be trained to output one or more of a road width of the roadway, a total number of lanes of the roadway, respective distances from respective shoulders, lane width of one or more lanes of the roadway, shoulder width of the roadway, a classification of the type of road, a classification of whether there is an intersection in the roadway, and classifications of lane line types around the automated vehicle on the roadway (e.g., solid lane lines, dashed lane lines, etc.). The one or more road analysis models 630 can be trained by a server or computing system using the various supervised or supervised learning techniques described herein. For example, the one or more road analysis models 630 can be trained using image data as input and ground truth labels corresponding to the type of output(s) that the one or more road analysis models 630 are trained to generate.

The road analysis models 630 include one or more object recognition models (or “engines”) for identifying, recognizing, and classifying objects in the roadway. The object recognition engine takes as input the image data from one or more cameras, which may include digital video or digital still images, and applies computer vision and trained machine-learning models to identify the objects and position of the object in space relative to the automated vehicle. In some implementations, the object recognition engine (or other component of the lane analysis module 601 or autonomy system 600) determines the lane (or shoulder) containing the object based upon the relative position in space of the object correlated against the relative position in space of each of the lanes or lane lines. Additionally or alternatively, the object recognition engine determines the lane containing the object based upon computer vision functions. The lane analysis module 601 identifies and compares the location of the pixels of the object in the image data correlated against the location of the pixels of the lanes or lane lines in the image data, or identifies an overlap amongst the pixels of the object and the pixels of the lane lines in the image data.

The lane analysis module 601 generates and outputs the labeled image data 650 including lane labels and object labels. The lane labels include various types information about the driving lanes, such as lane index values. The object labels include various types of information about the recognized objects, such as lane index values indicating the lane (or shoulder) where the object is located.

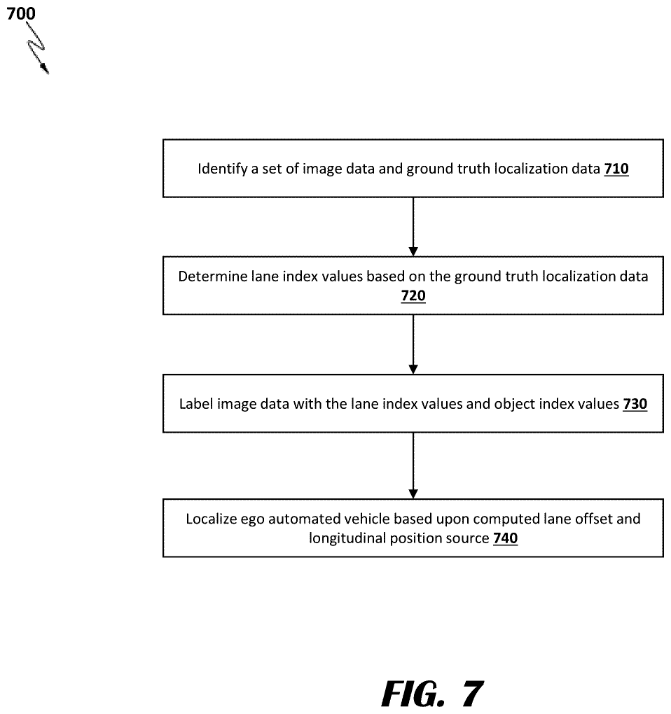

FIG. 7 is flowchart diagram showing operations of a method 700 for training machine learning models of an autonomy system of an automated vehicle for generating lane indices based on image data, according to an embodiment. The operations of the method 700 may be executed, for example, by any of the processors, servers, or automated vehicles described herein (e.g., processor or controller 300 of automated vehicle). It should be appreciated that other embodiments may comprise additional or alternative execution operations, or may omit one or more operations altogether. It should also be appreciated that other embodiments may perform certain execution operations in a different order. Operations discussed herein may also be performed simultaneously or near-simultaneously with one another.

The method 700 of FIG. 7 is described as being performed by a server, which may include the server systems 210 depicted in FIG. 2. However, it should be understood that any device or system with one or more processors, may perform the operations of the method 700, including the controller 300 depicted in FIG. 3 and the lane analysis module 600 depicted in FIG. 6. However, in some embodiments, one or more of the operations may be performed by a different processor, server, or any other computing device. For instance, one or more of the operations may be performed via a cloud-based service including any number of servers, which may be in communication with the processor of the automated vehicle and/or its autonomy system. Although the operations are shown in FIG. 7 having a particular order, it is intended that the operations may be performed in any order. It is also intended that some of these operations may be optional.

At operation 710, a server (e.g., the server system 210) can identify a set of image data captured by one or more automated vehicles (e.g., the vehicle 102) when the one or more automated vehicles were positioned in respective lanes of one or more roadways. The server can further identify respective ground truth localization data of the at least one automated vehicle representing a position of the automated vehicle on the roadway when the set of image data was captured. In an embodiment, the ground truth localization data can include multiple locations of the automated vehicle, with each or position within the roadway corresponding to a respective image in the set of image data. The image data may include LiDAR images (e.g., collections of LiDAR points, a point cloud, etc.) captured by LiDAR sensors of the automated vehicle or visual images (e.g., images, video frames) captured cameras of the automated vehicle. To obtain the image data, the autonomy system may perform features and functions similar to those described in connection with, for example, operation 402 of FIG. 4.

The ground truth localization data may be identified as stored in association with the set of image data received from one or more automated vehicles. The ground truth localization may include a relative and/or absolute position (e.g., GPS coordinates, latitude/longitude coordinates, etc.) and may be obtained separately or contemporaneously with the image data. In some embodiments, portions of the ground truth localization data may represent the ground truth location of the vehicle capturing the image data at the time the image was captured. For example, while capturing LiDAR or camera images or video frames, the automated vehicle may capture highly accurate GNSS data (e.g., using the GNSS 108). In some embodiments, the server can generate a confidence value for one or more of the ground truth information sources and the ground truth information sources may be selected based on the confidence values. Identifying the ground truth localization data may include retrieving the ground truth localization data from a memory or database, or receiving the ground truth localization data from the one or more automated vehicles that captured the set of image data. In an embodiment, at least a portion of the ground truth localization data may include data derived from an HD map. For example, localization of the automated vehicle may be determined based on one or more lane indications in the set of image data that are defined at least in part as a feature on a raster layer of the HD map, as described herein. Identifying the ground truth localization data can include any of the operations described in connection with operation 404 of FIG. 4.

At operation 720, the server can determine index values for the set of image data based on the ground truth localization data. The lane index values can identify the lane of a multiway roadway in which the automated vehicle was traveling when the automated vehicle captured an image of the image data. The lane index values can be relative to the leftmost or rightmost lanes of the multi-lane roadway. For example, a left lane index value can be an integer lane index that is relative to the leftmost lane, and a right lane index right lane index value can be an integer lane index that is relative to the rightmost lane, as described herein. The index values may be determined, at least in part, based on a localization process. For example, the server can utilize the ground truth localization data to identify a location of the automated vehicle in the roadway, as described herein (e.g., in connection with operations 406 and 408 of FIG. 4). Using that localization data, and data from, for example, HD maps or other data sources that include information relating to the roadway upon which the automated vehicle was traveling, the server can determine which lane of the roadway that the automated vehicle was traveling in when capturing each image of the set of image data. Using the number of lanes in the roadway, the server can then determine the lane offsets (e.g., the left and right lane offsets) for the respective lane for each image.

At operation 730, the server can label the set of image data with the plurality of lane index values to generate a set of training data for one or more machine learning models, as described herein. Labeling the data can include associating each image with the respective lane index values determined for the image in operation 720. Each respective lane index value can be utilized as a ground truth value for training a respective machine learning model, as described herein. Labeling can include performing operations similar to those described in connection with operation 408 of FIG. 4. In an embodiment, the server can allocate a portion of the training data as an evaluation set, which may not be utilized for training, but may be utilized to evaluate the performance of machine learning models trained using the training data described herein.

At operation 740, the server can train, using the labeled set of image data, machine learning models (e.g., the left lane index model 610, the right lane index model 620, etc.) that generate a left lane index value and a right lane index value as output. The machine learning models can include a first machine learning model that generates the left lane index value as output and a second machine learning model that generates the right lane index value as output. The machine learning models may be similar to the machine learning models 218 described herein, and may include one or more neural network layers (e.g., convolutional layers, fully connected layers, pooling layers, activation layers, normalization layers, etc.). Training the machine learning models can include performing operations similar to those described in connection with operation 410 of FIG. 4.

The machine learning models can be trained using supervised and/or unsupervised training techniques. For example, using a supervised learning approach, the machine learning models may be trained using providing training data and labels corresponding to the training data (e.g., as ground truth). The training data may include a respective label for each of the machine learning models for a given input image. During training, the machine learning models may be provided with the same input data, but may be trained using different and respective labels.

During training, input image data can be propagated through each layer of the machine learning models until respective output values are generated. The output values can be utilized with the respective left and right ground truth labels associated with the input image data (e.g., in operation 730) to calculate respective loss values for the machine learning models. Some non-limiting example loss functions used to calculate the loss values include mean squared error, cross-entropy, and hinge loss. The trainable parameters of the machine learning models can then be modified according to their respective loss values using a backpropagation technique (e.g., gradient descent or another type of optimizer, etc.) to minimize the loss values.

In an embodiment, the server can evaluate the machine learning models based on the set of training data allocated as an evaluation set. Evaluating the machine learning models can include determining an accuracy, precision and recall, and F1 score, among others. The machine learning models can be iteratively trained until a training termination condition (e.g., a maximum number of iterations, a performance threshold determined using the evaluation dataset, a rate of change in model parameters falling below a threshold, etc.) has been reached. Once trained, the machine learning models can be provided to one or more automated vehicles for execution during operation of the automated vehicle. The machine learning models can be executed by the automated vehicles to efficiently generate predictions of left and right lane index values, which may be utilized by the automated vehicle to perform localization in real time or near real time.

In an embodiment, the method 700 of FIG. 7 may be executed to train one or more additional machine learning models (e.g., the one or more road analysis model 630) using additional ground truth data and/or input data (e.g., any of the LiDAR system data 604, the visual system data 606, the GNSS system data 608, and/or the IMU system data 609, etc.). The additional machine learning models may have any suitable architecture (e.g., a neural network, a CNN, a regression model, etc.), and may be trained according to the supervised or unsupervised learning techniques described herein to output various characteristics of the roadway using at least image data described herein as input. For example, the additional machine learning models may be trained to output one or more of a road width of the roadway, a total number of lanes of the roadway, respective distances from respective shoulders, lane width of one or more lanes of the roadway, shoulder width of the roadway, a classification of the type of road, a classification of whether there is an intersection in the roadway, and classifications of lane line types around the automated vehicle on the roadway (e.g., solid lane lines, dashed lane lines, etc.).

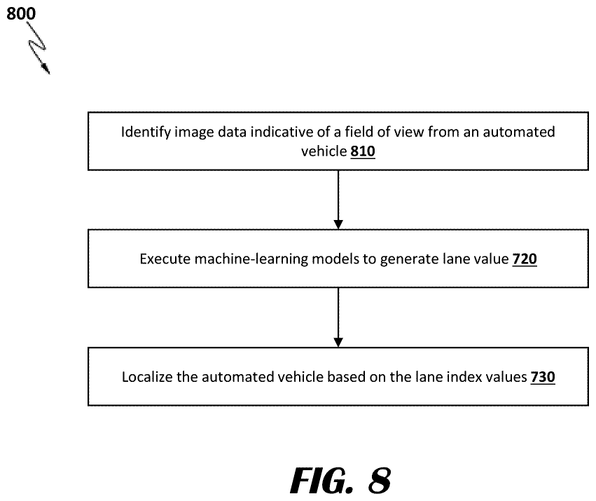

FIG. 8 shows operations of a method 800 for using machine learning models of an autonomy system of an automated vehicle to predict a lane index using real time image data, according to an embodiment. The operations of the method 800 may be executed, for example, by an automated vehicle system, including the automated vehicle, processor or controller 300, or the lane analysis module 601. It should be appreciated that other embodiments may comprise additional or alternative execution operations, or may omit one or more operations altogether. It should also be appreciated that other embodiments may perform certain execution operations in a different order. Operations discussed herein may also be performed simultaneously or near-simultaneously with one another.

The method 800 of FIG. 8 is described as being performed by an automated vehicle system (e.g., vehicle 102, controller 300, lane analysis module 601). However, in some embodiments, one or more of the operations may be performed by different processor(s) or any other computing device. For instance, one or more of the operations may be performed via a cloud-based service or another processor in communication with the processor of the automated vehicle and/or its autonomy system. Although the operations are shown in FIG. 8 as having a particular order, it is intended that the operations may be performed in any order. It is also intended that some of these operations may be optional.

At operation 810, the automated vehicle system of an automated vehicle can identify image data indicative of a field of view from the automated vehicle, when the automated vehicle is positioned in a lane of a multi-lane roadway. The image data may include LiDAR images (e.g., collections of LiDAR points, a point cloud) captured by LiDAR sensors of the automated vehicle or visual images (e.g., images, video frames) captured cameras of the automated vehicle. To identify the image data, operations similar to those described in connection with operation 502 of FIG. 5 may be performed. The image data may be captured by one or more cameras or sensors of the automated vehicle, and stored in memory of the automated vehicle system for processing, in a non-limiting example. In an embodiment, the operations of the method 800 may be performed upon capturing additional image data during operation of the automated vehicle on the multi-lane roadway.

At operation 820, the automated vehicle system can execute machine learning models (e.g., the left lane index model 610, the right lane index model 620, the road analysis model(s) 630) using the image data as input to generate a left lane index value and a right lane index value. To execute the machine learning models, the automated vehicle system can propagate the image data identified in operation 810 through each layer of each of the machine learning models, performing the mathematical calculations of each successive layer based at least on the output of each previous layer or the input data. Each of the machine learning models may respectively output one or more of a left lane index value and a right lane index value. The left lane index value can represent the index of the lane in which the automated vehicle is traveling relative to the leftmost lane, and the right lane index value can represent the index of the lane in which the automated vehicle is traveling relative to the rightmost lane. In an embodiment, the automated vehicle system can execute additional machine learning models (e.g., the one or more road analysis models 630) using input data to generate various predictions of road characteristics, as described herein. Executing the machine learning models may include performing any of operations 504-506 of FIG. 5.

At operation 830, the automated vehicle system can localize the automated vehicle based at least on the left lane index value and the right lane index value generated in operation 820. For example, the automated vehicle system may localize the automated vehicle by correlating the lane index values of the automated vehicle generated at operation 820 with longitudinal position data, which may be generated based on one or more of, for example, a GNSS system of the automated vehicle or an IMU system of the automated vehicle. Localizing the automated vehicle can include generating a accurate lateral position based on the lane index values and an accurate, longitudinal position based on the GNSS and the IMU. In an embodiment, the automated vehicle system may utilize lane offset values (e.g., generated according to the method 500 of FIG. 5) to localize the automated vehicle. Localizing the automated vehicle may include performing operation 508 of FIG. 5, or performing any operations described in connection with the localization module 314 of FIG. 3 or the localization module 640 of FIG. 6. Localization data may be stored in association with the image data, and may be transmitted to one or more remote servers, for example. The localization data may be utilized by autonomous navigation systems of the automated vehicle.

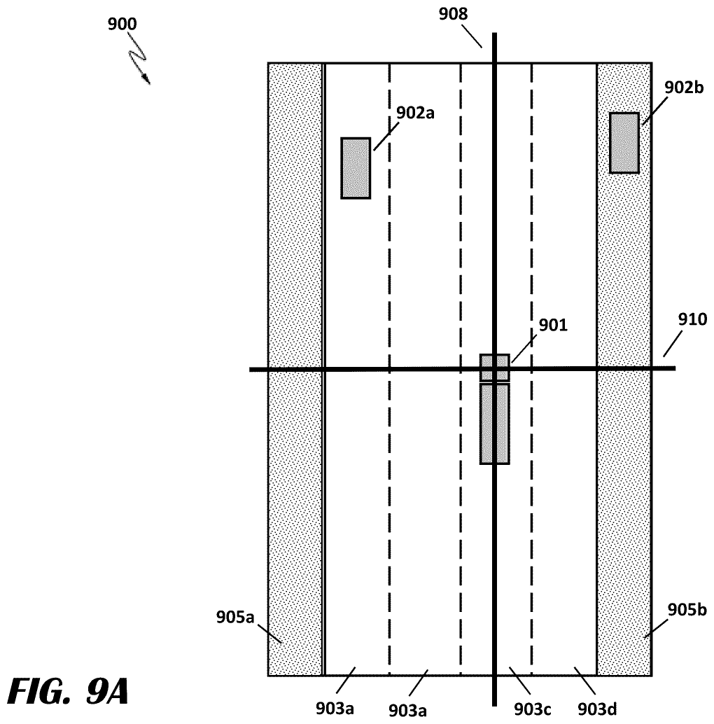

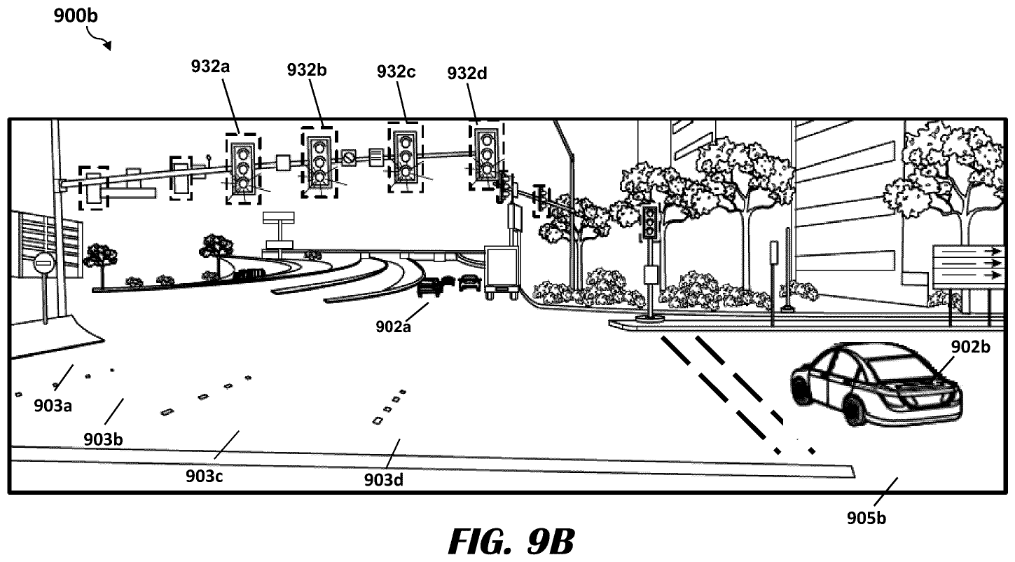

FIG. 9A depicts image data of an example of bird's eye view image 900a of a roadway generated by an autonomy system of an automated vehicle 901, according to an embodiment. FIG. 9B depicts another example of image data of an example image 900b of a roadway generated by the autonomy system of the automated vehicle 901, according to the embodiment. The autonomy system of the automated vehicle 901 uses the image data to identify objects and predict lane index values of the roadway by applying machine-learning models on the image data. As shown, the environment depicted in the image 900 includes the automated vehicle 901, traffic vehicles 902a-902b (generally referred to as “traffic vehicles 902”), travel lanes 903a-903d (generally referred to as “lanes 903”), a left shoulder 905a, and a right shoulder 905b (generally referred to as “shoulders 905”).

The autonomy system applies various types of metadata to the image data. The metadata may be stored into non-transitory machine-readable storage (e.g., local or remote database storage), in the form of metadata tags of the image 900 or database entries. The metadata includes information about, for example, attributes of the roadway or objects, among other types of information. Additionally or alternatively, the autonomy system applies certain metadata to the image data in the form of visualizations displayable in the image 900. The autonomy system updates the image data to include viewable overlays applied to the image 900, such as a longitudinal line 910, a travel lane indicator line 908.

The autonomy system applies the travel lane indicator line 908 over the particular travel lane 903c containing the automated vehicle 901. The autonomy system applies the longitudinal line 910 over the image 900 as an overlay that indicates the longitudinal position of the automated vehicle 901 with respective to the image 900. The autonomy system determines the longitudinal line 910 based, at least in part, upon localization processes described herein. The autonomy system applies the longitudinal line 910 over the particular longitudinal position of the automated vehicle 901 with respect to the roadway of the image 900.

The machine-learning models of the autonomy system may recognize and identify the travel lanes 903 and shoulders 905, and generate lane index values for the lanes 903 and shoulders 905. As an example, the autonomy system assigns a lane index value of ‘0’ or ‘−3’ to the left shoulder 905a, an index value of ‘1’ or ‘−2’ to the leftmost lane 903a, an index value of ‘2’ or ‘−1’ to the second lane 903b from the left, an index value of ‘3’ or ‘0’ to the third lane 903c from the left, an index value of ‘4’ or ‘+1’ to the fourth lane 903d from the left, and an index value of ‘5’ or ‘+2’ to the right shoulder 905b.

The machine-learning models executed by the autonomy system include models trained for computer vision, object recognition (e.g., road analysis models 630), and lane recognition (e.g., left lane index model 610, right lane index model 620), among others. When trained, the machine-learning models enable the autonomy system to perform various functions and features described herein, include object-to-lane association, shoulder classification, and image segmentation for lane associations.

The automated vehicle includes one or more cameras mounted at any location on the automated vehicle 901, which may be configured to capture images of the environment surrounding the automated vehicle 901 in any aspect or field of view (FOV) or perception field. The FOV can have any angle or aspect such that images of the areas ahead of, to the side, and behind the automated vehicle 901 may be captured. The image data generated by the camera may be sent to a perception module and stored in the local or remote memory. The autonomy system applies the machine-learning models to perform, for example, object detection or classification including the types of metadata information about the object (e.g., estimated distance information, velocity information, mass information) and image overlays (e.g., bounding boxes).

It should now be understood that image data (e.g., camera data and/or LiDAR data) obtained by one or more ego vehicles in a fleet of vehicles can be captured, recorded, stored, and labeled with ground truth location data for use to train a machine learning model(s) to predict a lane offset using only real time image data captured by an ego vehicle using a camera or LiDAR system and presenting the captured real time image data to the machine learning model(s). Use of such models may significantly reduce computational requirements aboard a fleet of vehicles utilizing the method(s) and may make the vehicles more robust to meeting location-based requirements, such as localization and behaviors planning and mission control.

In some embodiments, a stored digital map (e.g., HD map) or sensed map generated from sensor inputs indicate the position of various features and objects in the environment surrounding the automated vehicle 901. For example, a ground truth location of one or more lane indications or other features of the environment may be included as object data and/or image data in an image file or map file (e.g., in one or more raster layers of an HD map file or other semantic map files) as feature ground truth location data (e.g., lane indicator ground truth location data). In such embodiments, the ground truth location of the particular features (as determined from the digital map) and may be compared to a ground truth location of an automated vehicle 901 (as determined, for example, based on a GNSS signal or IMU signal) and a lane offset, or left and right lane indices, could be generated based on this difference between the ground truth location of the feature (e.g., the lane indication) and the vehicle feature (e.g., the centerline 908). This lane offset (or left and right lane indices) could also be used to label data to create the labeled ground truth offset data to train the one or more machine learning models based on the processes and methods described herein.

With respect to FIG. 9B, the roadway environment includes traffic lights 932a-932c (generally referred to as “traffic lights 932”) and other any number of other traffic vehicles 902, include a traffic vehicle 902a in a left hand lane 903a and a traffic vehicle 902b situated in a right intersection 905b.

The autonomy system applies an object recognition engine on the image data of the image 900b showing the environment. The object recognition engine of the machine-learning models recognizes and detects the traffic lights 932 and the vehicles 902. The object recognition engine may place bounding boxes around the detected traffic lights 932, denoting the portions of the image data containing the detected features. The autonomy system generates the lane labels containing information about the lanes 903, such as the lane index values, and object labels containing information about the recognized objects, such as object labels for the vehicles 902.

In some embodiments, the input to the machine-learning models of the autonomy system may perform certain pre-processing operations on the input image data. For example, an input image to the autonomy system can be divided into a grid of cells or pixels of a configurable size (e.g., based on the architecture of the machine-learning architecture). The machine-learning model can generate a respective prediction (e.g., classification, object location, object size, bounding box) for each cell extracted from the input image. As such, each cell can correspond to a respective prediction, presence, and location of an object within its respective area of the input image. The autonomy system may also generate one or more respective confidence values indicating a level of confidence that the predictions are correct. If an object represented in the image spans multiple cells, the cell with the highest prediction confidence can be utilized to detect the object. The autonomy system can output bounding boxes and class prediction probabilities for each cell, or may output a single bounding box and class prediction probability determined based on the bounding boxes and class probabilities for each cell.

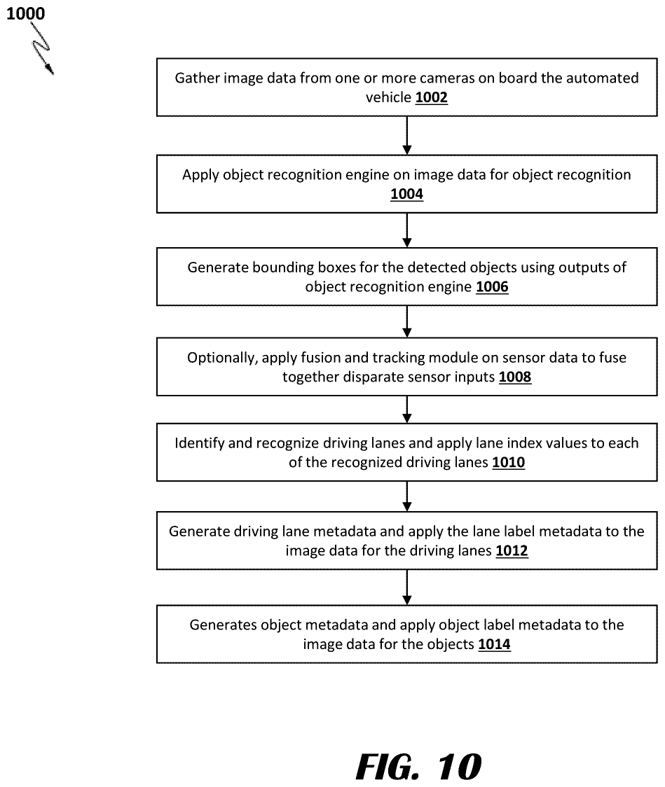

FIG. 10 shows operations of a method 1000 for recognizing lanes and objects by an autonomy system that manages operations of an automated vehicle, according to an embodiment. The autonomy system of the automated vehicle identifies driving lanes and vehicles, among other types of objects, from image data gathered from image inputs from cameras or other types of sensor inputs. The autonomy system assigns lane index values to the recognized driving lanes and shoulder lanes, and then assigns the lane index values to the vehicles in the particular driving lanes, thereby associating driving lanes with the vehicles in the driving lanes. Embodiments may include additional or alternative operations than those described in the method 1000, or may omit operations of the method 1000.

In operation 1002, the autonomy system gathers image data from one or more cameras on board the automated vehicle. Each camera captures imagery for the camera's FOV and generates digital image data as media feed of video data or still image snapshot data.

In operation 1004, the autonomy system executes an object recognition engine of a machine-learning architecture that applies a machine-learning model trained for object detection and recognition. The autonomy system applies the object recognition engine on a single frame of the camera data and generates one or more predictions of the objects in the environment.

The object recognition engine includes a trained object classifier. The object recognition engine may apply predicted two-dimensional bounding boxes on the predicted objects of the image, for dynamic and static objects. The classifier is trained to recognize some number of classes based on the feature vectors extracted as an array of image features from the image data. Non-limiting examples of object classes include vehicles, barrels, cones, road signs, lane lines, and the like.

In operation 1006, the autonomy system references the output of the object predictions and generates bounding boxes for the objects. For each bounding box, the autonomy system outputs, for example, a size, azimuth, distance, and elevation of the object and bounding box. For instance, the autonomy system predicts the distance, azimuth angle, and the elevation angle of the bounding box in space at the predicted distance.

Optionally, in operation 1008, the autonomy system sends the image data, enriched with bounding boxes and metadata labels, to a fusion and tracking module that takes an input from any number of different object detection modules and sensor types (e.g., camera inputs, LiDAR inputs, and radar inputs from respective object detection modules). The autonomy system may fuse respective object prediction from each of those respective object detection modules for each type of sensor modality.

Contemporaneously, in operation 1010, the autonomy system identifies and recognizes driving lanes and applies lane index values to each of the recognized driving lanes. The autonomy system may recognize the driving lanes by applying one or more machine-learning models based upon one or more types of sensor data. In some cases, the autonomy system recognizes the driving lanes using the LiDAR data, which the autonomy system combines from the LiDAR sensors of the automated vehicle to generate image data forming a sensed map of LiDAR data. The autonomy system may additionally or alternatively reference stored map data to identify lane lines. The autonomy system applies map localization functions using the sensed map and/or pre-stored map to identify the lane lines as features of the roadway. In some cases, the autonomy system recognizes the driving lanes using the image data, which the autonomy system may combine from the image data from any number of cameras of the automated vehicle. The autonomy system applies the object recognition functions on the image data to identify the driving lanes on the roadway. The autonomy system may further identify shoulder lanes of the roadway based upon the pre-stored map and/or sensed map. Additionally or alternatively, the autonomy system may identify the shoulder lanes of the roadway based upon the image data from the one or more cameras.

In operation 1012, the autonomy system generates driving lane metadata and applies the lane label metadata to the image data for the driving lanes. The lane label indicates information about the driving lanes and shoulder lanes, such as the lane index value, position, distance from the automated vehicle, width of the lane, and end-point of the lane, among other types of lane information.

In operation 1014, the autonomy system generates object metadata and applies object label metadata to the image data for the objects. The object label indicates information about the object (e.g., traffic vehicle), such as the lane index value, position, distance, azimuth, elevation, and velocity, among other types of information. As an example, the object label includes the lane index value that indicates the particular lane or shoulder containing the recognized object. As another example, the autonomy system recognizes traffic lights in the image data and applies a building box around each traffic light, and assigns the lane index value and other metadata information to the object labels of each traffic light.

In some embodiments, the autonomy system applies binary classifier on the image data that detects shoulder lanes of the roadway. In some cases, the binary classifier is trained to detect that a recognized vehicle is detect in a shoulder lane of the roadway in the image data. In some cases, the object label includes a metadata flag indicating whether the object associated with the object label is situated in a shoulder lane. For instance, the object label for a vehicle includes a binary flag (e.g., [0, 1]) indicating whether the classifier detected the vehicle broken down in the shoulder. In some cases, the lane label for a shoulder lane includes a metadata flag indicating whether the shoulder lane contains a vehicle. For instance, the lane label for the shoulder lane includes a binary flag (e.g., [0, 1]) indicating whether the classifier detected the shoulder lane contains a broken down vehicle.

The autonomy system may output the image data and related image data to downstream operational functions and components for operating the automated vehicle.

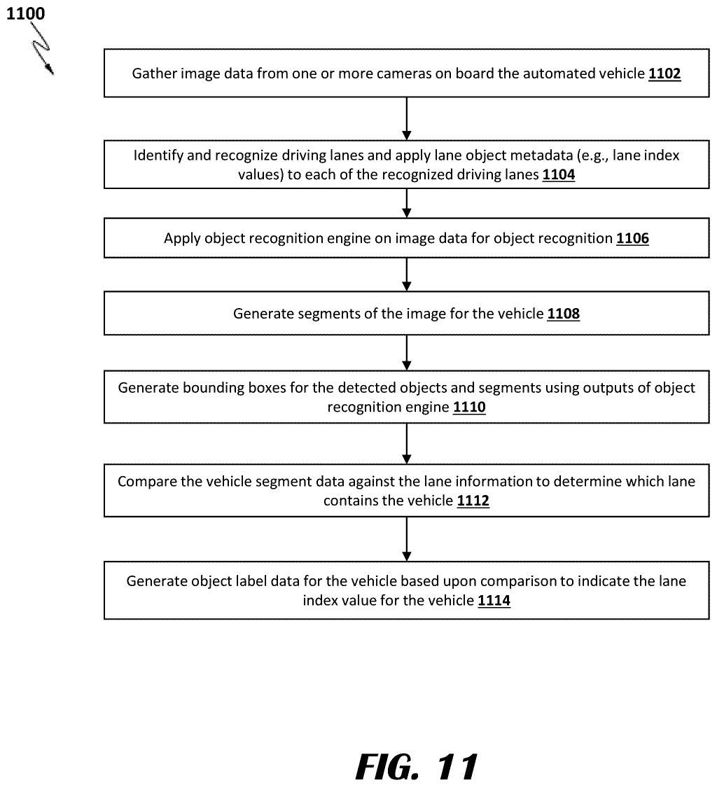

FIG. 11 shows operations of a method 1100 for recognizing lanes and objects by an autonomy system that manages operations of an automated vehicle, according to an embodiment. Embodiments may include additional or alternative operations than those described in the method 1100, or may omit operations of the method 1100.

The autonomy system of the automated vehicle identifies driving lanes and vehicles, among other types of objects, from image data gathered from image inputs from cameras or other types of sensor inputs. The autonomy system assigns lane index values to the recognized driving lanes and shoulder lanes, and then assigns the lane index values to the vehicles in the particular driving lanes, thereby associating driving lanes with the vehicles in the driving lanes. The autonomy system generates data segments from the image data, corresponding to creating segments of an image, such that a single image is segmented for portions of the image, such as segmented outputs of each lane line or segmented outputs of portions of the vehicle. The autonomy system compares the segmented portions of the image to detect that a lane contains a vehicle.

In operation 1102, the autonomy system gathers image data from one or more cameras on board the automated vehicle. Each camera captures imagery for the camera's FOV and generates digital image data as media feed of video data or still image snapshot data.

In operation 1104, the autonomy system identifies and recognizes driving lanes and applies lane index values to each of the recognized driving lanes. The autonomy system may recognize the driving lanes by applying one or more machine-learning models based upon one or more types of sensor data. In some cases, the autonomy system recognizes the driving lanes using the LiDAR data, which the autonomy system combines from the LiDAR sensors of the automated vehicle to generate image data forming a sensed map of LiDAR data. The autonomy system may additionally or alternatively reference stored map data to identify lane lines. The autonomy system applies map localization functions using the sensed map and/or pre-stored map to identify the lane lines as features of the roadway. In some cases, the autonomy system recognizes the driving lanes using the image data, which the autonomy system may combine from the image data from any number of cameras of the automated vehicle. The autonomy system applies the object recognition functions on the image data to identify the driving lanes on the roadway. The autonomy system may further identify shoulder lanes of the roadway based upon the pre-stored map and/or sensed map. Additionally or alternatively, the autonomy system may identify the shoulder lanes of the roadway based upon the image data from the one or more cameras.

In operation 1106, the autonomy system executes an object recognition engine of a machine-learning architecture that applies a machine-learning model trained for object detection and recognition. The autonomy system applies the object recognition engine on a single frame of the camera data and generates one or more predictions of the objects in the environment.

The object recognition engine includes a trained object classifier. The object recognition engine may apply predicted two-dimensional bounding boxes on the predicted objects of the image, for dynamic and static objects. The classifier is trained to recognize some number of classes based on the feature vectors extracted as an array of image features from the image data. Non-limiting examples of object classes include vehicles, barrels, cones, road signs, lane lines, and the like.

In operation 1108, the autonomy system generates segment data from the image data corresponding to segments of an image. The autonomy system identifies and classifies the object as, for example, a vehicle in the image. The autonomy system then generates segment data for image segments based on portions of the vehicle. For instance, the autonomy system generates image segments containing wheels of the vehicle.

In operation 1110, the autonomy system references the output of the object predictions and generates bounding boxes for the objects and segments. For each bounding box, the autonomy system outputs, for example, a size, azimuth, distance, and elevation of the object or segment and a corresponding bounding box around the object or the image segment containing the portion of the object. For instance, the autonomy system predicts the distance, azimuth angle, and the elevation angle of the bounding box in space at the predicted distance.

In operation 1112, the autonomy system compares the vehicle segment data against the lane information to determine which lane contains the vehicle. As an example, the autonomy system generates and applies metadata labels for image segments of the recognized driving lines and any shoulder lanes as, for example, Left_Shoulder, Lane_Line_0, Line_Line_1, Lane_Line_2, Line_Line_3, and Right_Shoulder. The object recognition engine recognizes a vehicle and portions of the vehicle (e.g., wheels, auto body). The autonomy system generates image segments around, for example, each wheel of the vehicle. The autonomy system compares the location (indicated in the object label metadata) or image pixels of the image segments for the wheels, against the location or image pixels of the lane lines or image segments of the lane line. Based on comparing the location information or the pixels, the autonomy system may determine whether part of the wheel is collocated with a lane line, or whether pixels of part of the wheel overlap pixels of one or more lane lines. For instance, the autonomy system may determine which lane the wheel or vehicle is located in, or determine whether a vehicle is changing lanes or occupies multiple lanes.

In operation 1114, the autonomy system generates an object label data for the vehicle based upon comparison to indicate the lane index value for the vehicle. The autonomy system generates object metadata and applies object label metadata to the image data for the objects. The object label indicates information about the object (e.g., traffic vehicle), such as the lane index value, position, distance, azimuth, elevation, and velocity, among other types of information. As an example, the object label includes the lane index value that indicates the particular lane or shoulder containing the recognized object. As another example, the autonomy system recognizes traffic lights in the image data and applies a building box around each traffic light, and assigns the lane index value and other metadata information to the object labels of each traffic light.

The autonomy system may output the image data and related image data to downstream operational functions and components for operating the automated vehicle.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for managing location information in automated vehicles, the method comprising:
obtaining, by a processor of an automated vehicle, image data from a camera on the automated vehicle, the image data includes a digital representation of imagery in a field-of-view of the camera including an operational environment with one or more objects including a vehicle and a roadway having a plurality of lanes;
identifying, by the processor, in the image data the vehicle and the one or more lanes;
determining, by the processor, that the vehicle is situated in a shoulder lane of the plurality of lanes of the roadway;
for each lane, applying, by the processor, to the image data a lane label associated with the particular lane; and
updating, by the processor, the image data by applying a vehicle label indicating the shoulder lane for the vehicle.

2. The method according to claim 1, further comprising executing, by the processor, one or more driving operations based upon the vehicle label and each lane label.

3. The method according to claim 1, wherein the lane index value of the lane label represents the lane of a number of lanes from a leftmost or rightmost lane to the lane in which the at least one automated vehicle was positioned.

4. The method according to claim 1, further comprising applying, by the processor, in the object label for the vehicle a flag indicating the object is in the shoulder lane.

5. The method according to claim 1, further comprising, for each driving lane of the one or more lanes, applying, by the processor, to the image data a lane label associated with the particular lane and indicating a lane index value.

6. The method according to claim 5, wherein the lane index value indicates the vehicle is on the shoulder lane.

7. The method according to claim 1, wherein the processor determines that the shoulder having the vehicle is a left shoulder.

8. The method according to claim 1, wherein the processor determines that the should having the vehicle is a right shoulder.

9. The method according to claim 1, further comprising applying, by the processor, a shoulder classifier on the image data to determine the vehicle is in the shoulder.

10. The method according to claim 9, further comprising applying, by the processor, in the object label for the vehicle a flag indicating the object is in the shoulder lane.

11. A system for managing location information in automated vehicles, the system comprising:
a datastore of an automated vehicle comprising non-transitory machine-readable storage configured to store image data from a camera of the automated vehicle, the image data includes a digital representation of imagery in a field-of-view of the camera including an operational environment with one or more objects and a roadway having one or more driving lanes; and
a processor configured to execute the executable instructions, configured to:
obtain a single snapshot of the image data of the camera from the datastore;
identify in the image data the vehicle and the one or more lanes;
determine that the vehicle is situated in a shoulder lane of the plurality of lanes of the roadway;
for each lane, apply to the image data a lane label associated with the particular lane; and
update the image data by applying a vehicle label indicating the shoulder lane for the vehicle.

12. The system according to claim 11, wherein the processor is further configured to execute one or more driving operations based upon the vehicle label and each lane label.

13. The system according to claim 11, wherein the lane index value of the lane label represents the lane of a number of lanes from a leftmost or rightmost lane to the lane in which the at least one automated vehicle was positioned.

14. The system according to claim 11, wherein the processor is further configured to apply in the object label for the vehicle a flag indicating the object is in the shoulder lane.

15. The system according to claim 11, wherein the processor is further configured to for each driving lane of the one or more lanes, apply to the image data a lane label associated with the particular lane and indicating a lane index value.

16. The system according to claim 15, wherein the lane index value indicates the vehicle is on the shoulder lane.

17. The system according to claim 11, wherein the processor determines that the shoulder having the vehicle is a left shoulder.

18. The system according to claim 11, wherein the processor determines that the shoulder having the vehicle is a right shoulder.

19. The system according to claim 11, wherein the processor is further configured to apply a shoulder classifier on the image data to determine the vehicle is in the shoulder.

20. The system according to claim 19, wherein the processor is further configured to apply in the object label for the vehicle a flag indicating the object is in the shoulder lane.
